(19) United States
(12) Patent Application Publication
(10) Pub. No.: US 2004/0125815 A1
(43) Pub. Date: Jul. 1, 2004

(54) Packet transmission apparatus and method thereof, traffic conditioner, priority control mechanism and packet shaper

(76) Inventors: Mikio Shimazu, Kasuya-Gun (JP); Masayuki Kumazawa, Kasuya-Gun (JP); Makoto Matuoka, Iizuka-Shi (JP); Hiroki Gotoh, Kadoma-Shi (JP); Akira Sakai, Yokohama-Shi (JP); Yuji Shimizu, Koga-Shi (JP); Masaaki Hoshida, Yokohama-Shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/600,765

(22) Filed: Jun. 23, 2003

(30) Foreign Application Priority Data
Jun. 24, 2002 (JP) 2002-182737
Jun. 28, 2002 (JP) 2002-189435
Nov. 14, 2002 (JP) 2002-331130

(51) Int. Cl. H04L 12/28; H04L 12/56

(52) U.S. Cl. 370/411; 370/395.4; 370/235

(57) ABSTRACT

A packet transmission method wherein, when the sum of the bands of a plurality of flows including packets having the same priority exceeds the guaranteed band shared by these flows, a packet belongs to a flow having an earlier transmission start time is given a higher priority than a packet belongs to a flow having a later transmission start time on the in order of arrival basis based on the transmission start time. A classifier controls the token thresholds and a priority control mechanism controls the discard thresholds based on each flow to use for deciding the conditions.

### BACKGROUND OF THE INVENTION

1. Field of the Invention

The present invention relates to a packet transmission method for assuring QoS (Quality of Service) and related art thereof.

2. Description of the Related Art

To begin with the conclusion, in the prior art, there is no pre-processing unit or element equivalent thereto, which is capable of dynamically determining the priority of the packets belongs to the flows. A packet transmission apparatus possesses a traffic conditioner, a priority control mechanism, a packet shaper and so on. This packet transmission apparatus has some technical problems, and is not enough to correspond to the policy.

These problems will be described in order below.

<Traffic Conditioner and Priority Control Mechanism>

As a conventional QoS technique in an IP network, the DiffServ (RFC2475) regulated by IETF (Internet Engineering Task Force).

Referring to FIG. 26, the architecture of the DiffServ will be described. According to the DiffServ, QoS classes such as EF (virtual leased line) class, AF (minimum band assurance) class and BE (best-effort) class are specified as the standard.

According to the DiffServ, a range, which the same rule concerning the quality assurance can be applied, is called as “DS domain” 501. The DS domain 501 is used as, for example, an ISP (Internet Service Provider) network, a corporate network, etc.

Packet transmission apparatus (router, switch, gateway, etc.,) located at the boundary of the DS domain 501 are respectively called, an “edge node” 502, 503 and 504; and packet transmission apparatus located within the DS domain 501 are called, a “core node” 505 and 506, respectively.

As shown in FIG. 27, provided for each input interface of the edge nodes 502, 503 and 504 is a traffic conditioner (Traffic Conditioner) 510 that monitors packets 511, which flow into the DS domain 501.

The traffic conditioner 510 has an MF (Multi-Field) classifier 512. The MF classifier 512 refers to header information of the incoming packets 511, classifies which QoS class the respective packets belong to, and measures the used bands for each QoS class.

The MF classifier 512 sets a value to a DSCP (DiffServ Code Point: equivalent to the priority) field of the incoming packet 511 depending on breach of contract.

Also, as shown in FIG. 28, the core nodes 505 and 506 have a priority control mechanism, respectively, which has a BA (Behavior Aggregate) classifier 521. The classifier 521 classifies the packet 511 referring to the value of the DSCP that has only been set by the edge nodes 502, 503 or 504, and performs transfer processing (priority control) of the packets 511 suitable for the value of the DSCP.

(Problem 1) Relevant to the Traffic Conditioner

In the conventional DiffServ, traffic measurement, DSCP marking (setting of priority) and packet discard are performed by using a mechanism called a token bucket.

Hereinafter, for simple depiction, taking a case, in which two classes, i.e., AF class (high priority) and other than the AF class (low priority) are included, as an example, a description will be made with reference to FIG. 27.

FIG. 27 is a block diagram of a conventional traffic conditioner. The traffic conditioner 510 is used in each input interface of the edge nodes 502, 503 and 504, and monitors the packets 511.

In the AF class, a minimum guaranteed band has been specified as a contract band, and the MF classifier 512 checks whether or not the packet 511 is a packet of the AF class.

When the packet 511 is a packet other than the AF class, the MF classifier 512 sets a mark (DSCP3) of a priority of a class other than the AF class to the packet 511, and outputs the packet to the outside of the traffic conditioner 510.

When the packet 511 is a packet of the AF class, the MF classifier 512 outputs the packet 511 to a measurement priority setting unit 513 that has the token bucket mechanism.

The measurement priority setting unit 513 has a token buffer 514 in which tokens 515 are accumulated at a predetermined rate “r.” When the packet 511 is input by the measurement priority setting unit 513, the measurement priority setting unit 513 compares the packet length thereof with the token amount accumulated in the token buffer 514 at the point of inputting thereof.

If the token amount>=the packet length, the measurement priority setting unit 513 determines that the packet 511 is within the guaranteed band; and sets a mark of high priority (DSCP1) to the packet 511, and outputs the packet 511 outside of the traffic conditioner 510. At this time, the token within the token buffer 514 is reduced by an amount equivalent to the packet length of the packet 511.

On the other hand, if the token amount<the packet length, the measurement priority setting unit 513 determines that the packet 511 exceeds the guaranteed band; and sets a mark of low priority (DSCP2) to the packet 511 and outputs the packet 511 outside of the traffic conditioner 510.

As described above, in the conventional traffic conditioner 510, there are a plurality of flows of the AF class, the conventional traffic conditioner 510 measures these flows without distinguishing, and this checks whether the sum of the bands of the flows having the same priority is within the guaranteed band or exceeds the guaranteed band.

Here, in the case that the sum of the bands of the flows having the same priority exceeds the guaranteed band, the packets equivalent to the flows exceeding the guaranteed band in the plurality of flows of the AF class (high priority) are marked as DSCP2 (low priority) without distinguishing the flows.

Since the packet of DSCP2 is excluded from the band assurance, when confliction has occurred, the packets are discarded. That is, any flow of the AF class may be discarded all alike without being distinguished.

When explaining the aspects of this phenomenon, the above is as follows. That is, in such a case that a plurality of users receives images by using a packet transmission of the AF class to view them, when confliction has occurred, quality of each image viewed by the users is lowered simultaneously.

(Problem 2) Relevant to the Priority Control Mechanism

FIG. 28 is a block diagram of the conventional priority control mechanism. A priority control mechanism 520 shown in FIG. 28 is used in the output interface of the core nodes 505 and 506 and edge nodes 502, 503 and 504 shown in FIG. 26.

The priority control mechanism 520 classifies the packet 511 based on the DSCP marked by an edge nodes 502, 503 or 504, and performs transfer processing (queuing, scheduling) in accordance with the DSCP. Hereinafter, for simple depiction, a case that two classes are included will be taken as an example.

The classifier 521 determines which QoS class the packet 511 should belong to based on the DSCP.

The classifier 521 classifies a packet of class 1 into a queue 522, and inserts a packet of class 2 into a queue 523. When the queue 522 or 523 is full of packets, the packet is discarded without being inserted into the queue 522 or 523.

Regarding these queues 522 and 523, the scheduler 524 determines the queue to be taken out and the packet amount to be sent out in accordance with an algorithm such as PQ (Priority Queuing) or WRR (Weighted Round Robin). Based on the determination, the packet is output from the queue 522 or queue 523 outside of the priority control mechanism 520.

Here, in case of the AF (minimum band assurance) class, the packet rate served by the scheduler 524, i.e., available band at confliction is different from that at non-confliction.

If the contract band is exceeded at confliction, there may be a case where the packet of DSCP2, which should be processed first, is discarded.

The measurement of the packet and the priority setting (of DSCP1 or DSCP2) are carried out at the point of packet inputting to the DS domain, and these depend on the sender of the packet.

However, there may be a case where, regarding the packet to be output from the DS domain 501, the band assurance should be made in accordance with the band used by a receiver. In this case, there may be a situation on the basis of the sender that a packet is discarded even the packet is marked as DSCP1 (high priority) when the sum of the packet exceeds the guaranteed band of the receiver.

<packet shaper> In a packet transmitter apparatus used in the IP network, when the (sum of the bands of the input interface) exceeds the (band of output interface), there may be a case where confliction occurs at the output interface, and the packet is discarded.

When confliction occurs, for example, when image packets are being sent, the quality of pictures is deteriorated more than the original quality due to the discarding of packets. In order to solve the problem as described above, the following related arts 1 and 2 have been proposed.

(Related Art 1)

The related art 1 relates to a packet transmission apparatus provided with a scheduler based on PQ (Priority Queuing). For further clarification, refer to, for example, “Copious annotations: Network QoS Technique,” by Iwao Toda, Ohm, 2001; page 29: FIG. 3.2(a).

FIG. 29 is a block diagram of a conventional packet shaper. Hereinafter, for simple depiction, a case in which two kinds of flows, i.e., high priority flow (for example, of image packet) and low priority flow (for example, of ftp packet) are included will be described.

Referring to FIG. 29, a classifier 601 refers to the header information of an input packet, and classifies the packet to the packet of high priority flow or the packet of low priority flow.

The packet of high priority flow is accumulated in a high priority packet queue 602, and the packet of low priority flow is accumulated in a low priority packet queue 603.

A scheduler 604 performs scheduling of a packet, which is to be taken out next, at an output rate of x in accordance with PQ.

In particular, when any packet exists in the high priority packet queue 602, the scheduler 604 always takes out a high priority packet; when no packet exists in the high priority packet queue 602, the scheduler 604 takes out a packet from the low priority packet queue 603.

Owing to this arrangement, when input rate>output rate, since the low priority packet is discarded first, the packet of high priority flow can be protected.

(Related Art 2)

The related art 2 relates to the IntServ organized by IETF (Internet Engineering Task Force) and the resource reservation protocol RSVP thereof. For more detailed information, refer to, for example, “Resource ReSerVation Protocol-Version 1 Functional Specification”: R. Branden et al., RFC2208, 1997.

Referring to FIG. 30 and FIG. 31, the architecture of the Intserv and the RSVP, which is a signaling protocol therefor, will be described.

In the architecture of the Intserv, when a terminal requests some QoS to the network, signaling is carried out to every router 607 and 608 on the path to reserve resources prior to each flow, and then transmission is carried out. The RSVP is a signaling protocol for this resource reservation.

As shown in FIG. 30, according to the RSVP, the following processing is performed. In the following PATH message, a domain for writing “previous hop” is provided.

(1) First, a sender host 605 transmits a PATH message in the same manner as the transmission of ordinary data traffic.

(2) Each router 607 and 608 on the path receives the PATH message, stores the IP address written in the “previous hop” of the received PATH message, writes the IP address of its own in the “previous hop” of the PATH message, and transmits to the next stage.

For example, when the router 607 receives a PATH message from the sender host 605, the IP address of the sender host 605 is written in the “previous hop” of the PATH message, the router 607 stores the IP address of the sender host 605, sets the IP address of the router 607 itself in the “previous hop” of the PATH message, and transfers the PATH message to the router 608.

The routers 607 and 608 are for transmitting the PATH message along the same route that is used by an application operating in the sender host 605. When the PATH message arrives at a receiver host 606 from the sender host 605, the intended path is established by tracing back the IP addresses stored by each router 607 and 608.

(3) When receiver host 606 receives the PATH message, the receiver host 606 transmits a RESV message to the router 608 indicated by the “previous hop” of the PATH message, thereby the resource reservation request starts.

Of course, a RESV message transmitted from the receiver host 606 to the sender host 605 goes through the path through which the PATH message has passed in reverse.

(4) The router 608 checks whether or not the resource request by the RESV message is acceptable.

When it is unacceptable, the router 608 refuses the reservation request. When it is acceptable, the router 608 reserves the necessary resources, and further transmits the RESV message, which has been previously reserved in the “previous hop,” to the router 607 to request the resource reservation. When the RESV message reaches the sender host 605 successfully, the resource reservation has been completed.

Referring to FIG. 31, the operation of the above in the router 608 will be described in detail. In FIG. 31, when a RSVPD (RSVP daemon) 610 receives the RESV message, the RSVPD 610 communicates with an admission control unit 615 to check whether or not the resources for offering the requested QoS are available in the router 608.

After that, the RSVPD 610 communicates with a policy control unit 614 to check whether or not the user has the control authority for carrying out the reservation.

When whichever the checking has failed, the RSVPD 610 transmits an error notice to the application process, which has issued the request.

When each check has been completed successfully, the RSVPD 610 sets up the parameters for a classifier 612 and a scheduler 613, etc., to reserve the intended QoS resources.

(5) The sender host 605 receives the reservation request indicating that the reservation has been issued from the router 607 of the next hop.

As described above, in the Intserv, every router 607 and 608 on the path is made to previously reserve the necessary QoS resources using the RSVP. Accordingly, as for the flow of which a reservation has been completed successfully, the requested quality is guaranteed even when confliction occurs.

However, as for the flow of which a reservation has failed, the packet is refused to flow into the network.

(Related Art 3)

In the related art 3, as the non-priority packets are discarded first on the basis of the absolute priority scheduling, unlike the non-priority packets, the priority packets are protected.

However, for example, like the case where a plurality of image flows are included, when the sum of the priority packets exceeds the band of the output interface, the high priority packets are also discarded.

At this time, since the packets are discarded irrespective of the flow, lowering quality occurs for each image.

(Related Art 4)

In the related art 4, when the sum of the high priority packets exceeds the band of the output interface, the band reservation for a new flow is rejected at the signaling. Accordingly, the packets of the reserved high priority flow are not discarded.

Therefore, such a case where the sum of the high priority packets exceeds the band of the output interface does not occur. This means that quality of each image is not lowered.

However, to achieve the Intserv architecture, the terminal requires to be provided with the band reservation function, and each node requires to be provided with a function to accept reservations such as admission control, policy control, etc. Accordingly, there arise such problems that not only the cost of the entire system increases but also the flow of a terminal having no reservation function is not protected.

<Handling of the Policy>

The packet transmission apparatus has various modes such as a router, switch or a board which serves the main functions thereof. As for the scheduling method for carrying out the band control based on each priority class, which is used in a packet transmission apparatus of this type, WFQ (Weighted Fair Queuing) is the most popular. In this method, a plurality of queues equivalent to the number of the priority classes is provided, and the packets are transferred in accordance with the weight set for each priority class, thereby band assurance is carried out.

As literature 3 concerning the technical field as described above, the following document is mentioned. That is, “Weighted Round Robin Cell Multiplexing in a General-Purpose ATM Switch Chip” by Manolis Katevenis; IEEE Journal on selected areas in communications, Vol. 9 No, 8 Oct. 1991. According to a WRR (Weighted Round Robin) scheduler described in the above document, packets are transmitted in accordance with values, which are set by a plurality of packet storage queues, thereby line bands are distributed.

Furthermore, in literature 4, “Random Early Detection Gateways for Confliction Avoidance” by Floyd, S., and Jacobson, V.; V. 1 N. 4, August 1993, p.397-413,” an RED (Random Early Detection) technique is disclosed, in which arrival packets are discarded in a stochastic manner based on the accumulated amount of packets in a packet queue. Thereby the fairness of bands of the flows within a queue is achieved.

As a further advanced literature 5, “http://www.cisco.com/univercd/cc/td/doc/product/software/ios121/121cgcr/qos_c/qcd intro.htm#xtocid19969” is given. In the document, a technique, in which the RED technique is combined with WRED (Weighted RED) and WFQ introduced with the priority, is disclosed.

According to the above technique, in addition to that the bands are distributed to each queue, packet discard processing is carried out based on the priority in the plurality of flows within a queue. By using this technique, it is possible not only to carry out band distribution based on the traffic class for classifying the flows of the packets but also to carry out the priority control on each flow within a class.

However, the technique according to literature 5 assumes that the priority has been previously set statically. Accordingly, it is impossible to carry out the priority control of the flows of the packets dynamically based on the state of the traffic.

Furthermore, in literature 6 Japanese Unexamined Patent Publication No. 2001-144803, a technique is disclosed, in which a plurality of quality classes is previously defined, and the quality classes are reset based on the user's utility time. However, in this case also, the quality classes are just rated on the basis of the same policy and are re-rated. Therefore, in such case as a plurality of flows of packets, which are subject to different policies, flows in a mixed manner through the same transmission path, satisfactory response to the packets is impossible.

On the other hand, it is expected that such a situation as a plurality of flows of packets, which are subject to different policies, flows in a mixed manner through the same transmission path will increase more and more as network circumstances expand widely.

### OBJECTS AND SUMMARY OF THE INVENTION

Accordingly, a first object of the present invention is to provide a technique whereby, even when confliction occurs and available bands decrease, it is possible to prevent the transmission quality of each flow being deteriorated simultaneously.

A second object of the present invention is to provide a technique whereby, even when a plurality of image flows exists and the sum of the packets with high priority exceeds the bands of an output interface, it is possible to prevent the picture quality of the entire images from being deteriorated, and pre-signaling is not necessary resulting in a cost reduction of the entire system.

A third object of the present invention is to provide a technique whereby, even when flows of packets based on various policies flow in a mixed manner, packet transmission can be carried out while respecting the respective policies.

To achieve the first object, the invention adopts the following configuration.

In a packet transmission method according to the first aspect of the present invention, when a plurality of flows including packets having the same priority share an guaranteed band, these flows are handled while making a difference between the priority of the packets belong to at least one flow in these flows and the priority of the packets belong to the flows different from the one flow in these flows.

Owing to this arrangement, since a difference is given between the priorities of the flows, the packets belong to a flow which have relative priority is not discarded. Accordingly, the transmission quality of the flow is maintained. As a result, even when confliction occurs and available bands are reduced, it is possible to prevent the transmission quality of each flow from being deteriorated simultaneously.

In a packet transmission method according to the second aspect of the present invention, the difference in the priority is made on the in order of arrival basis based on the transmission start time of the flows.

In a packet transmission method according to the third aspect of the present invention, when the sum of the bands of a plurality of flows including packets having the same priority exceeds the guaranteed band shared by these flows, these flows are handled on the in order of arrival basis based on the transmission start time of the flows so that a packet belongs to a flow having an earlier transmission start time is given with the priority higher than a packet belongs to a flow having a later transmission start time.

In a packet transmission method according to the fourth aspect of the present invention, when the sum of the bands of a plurality of flows including packets having the same priority exceeds the guaranteed band shared by these flows, these flows are handled on the in order of arrival basis based on the transmission start time of the flows so that a packet belongs to a flow having an earlier transmission start time is given with the priority higher than a packet belongs to a flow having a later transmission start time.

In a packet transmission method according to the fifth aspect of the present invention, when the sum of the bands of a plurality of flows including packets having the same priority exceeds the guaranteed band shared by these flows, a packet belongs to a flow having a later transmission start time is discarded earlier than a packet belongs to a flow having an earlier transmission start time on the in order of arrival basis based on the transmission start time.

Owing to this arrangement, a flow having an earlier transmission start time is handled advantageously. Accordingly, it is possible to prevent the quality of the earlier flow from being deteriorated by a later flow that results in a reasonable transmission control.

To achieve the second object, the invention adopts the following configurations.

In a packet shaper according to a sixth aspect of the present invention, a packet queue that accumulates packets is included wherein, when a plurality of flows, which are accumulated in the packet queue and includes packets with the same priority, exists, the flows are handled while a difference is given between the priority of a packet belongs to at least one flow in these flows and the priorities of the packets belong to the flows different from the one flow in these flows.

Owing to this arrangement, since a difference is given between the priorities of the flows, a packet belongs to a flow, which is relatively advantageous, is not discarded. Accordingly, the transmission quality of the flow is maintained. As a result, even when a plurality of flows with high priority, and the sum of the packets with high priority exceeds the band of the output interface, it is possible to prevent the transmission quality of each flow from being deteriorated simultaneously.

In a packet shaper according to a seventh aspect of the present invention, a difference is given between the priorities on the in order of arrival basis based on the transmission start time of the flows.

In a packet shaper according to an eighth aspect of the present invention, when the sum of the bands of a plurality of flows including packets having the same priority exceeds the output rate of the packet shaper, these flows are handled on the in order of arrival basis based on the transmission start time of the flows so that the priority of a packet belongs to a flow having an earlier transmission start time is higher than the priority of a packet belongs to a flow having a later transmission start time.

In a packet shaper according to a ninth aspect of the present invention, when the sum of the bands of a plurality of flows including packets having the same priority exceeds the output rate of the packet shaper, these flows are handled on the in order of arrival basis based on the transmission start time of the flows so that a packet belongs to a flow having a later transmission start time is discarded earlier than a packet belongs to a flow having an earlier transmission start time.

Owing to the above arrangements, a flow having an earlier transmission start time is handled advantageously. Accordingly, it is possible to prevent the quality of an earlier flow from being deteriorated by a later flow that results in a reasonable transmission control.

To achieve the third object, the invention adopts the following configurations.

In a packet transmission apparatus according to a tenth aspect of the present invention comprises of; a packet receiving unit for receiving packets from the outside, a discard decision unit that determines whether or not to discard the received packets, a queue into which the packets determined not to discard by the discard decision unit are inserted in order, a packet transmission unit that transmits the packets output from the queue to the outside, a flow control information storage unit that connects information defining a flow of a packet with information concerning the priority of the packet belongs to the flow and holds the same, a quality determination unit that dynamically determines the priority of a packet belongs to a flow quality in accordance with a specific policy while reflecting the usage situation of the transmission resources, and a mode decision unit that performs a static/dynamic decision, i.e., whether to statically determine the information concerning the priority of the received packet as the information held by the flow control information storage unit, or to dynamically determine by the quality determination unit.

In the above arrangement, the flow control information storage unit is configured as described above, and a quality determination unit, which dynamically determines the priority of a packet belongs to a flow in accordance with a specific policy while reflecting a usage situation of the transmission resources is provided. Accordingly, it is possible to determine the service quality in accordance with the characteristics and the purpose of the flow. The packet transmission in which the policy is respected can be achieved.

For example, a group of common protocols, a user group of common charges, a group of common applications and the like can be included into a common set of service quality, and service quality thereof can be determined as a set. As a result, the reflection of the policy can be carried out easily.

In a packet transmission apparatus according to a eleventh aspect of the present invention, the information concerning the priority of a packet belongs to a flow of the flow control information storage unit is configured so as to be a basis for the static/dynamic decision.

In the above arrangement, the information concerning the priority of a packet, which is belongs to a flow of the flow control information storage unit, serves as a basis for the static/dynamic decision. Irrespective of the static or dynamic decision, since the service quality is assessed based on the same scale, the discard decision unit does not have to distinguish the static or dynamic decision. That is, the discard decision unit can determine whether or not to discard in a simple process, and the discard decision unit can be easily incorporated into the hardware.

In a packet transmission apparatus according to a twelfth aspect of the present invention, the information concerning the priority of a packet belongs to a flow of the flow control information storage unit indicates an invalid priority when indicating to determine dynamically.

Owing to the above arrangement, based on whether or not the priority is invalid, the static/dynamic decision can be clearly distinguished. Furthermore, when indicating to determine dynamically, since the priority is invalid, it is possible to prevent the priority of the static decision from being mixed therewith. Accordingly, the information indicating to be a dynamic decision does not prevent a certain value for static decision from being stored.

In a packet transmission apparatus according to a thirteenth aspect of the present invention, the queue and the quality determination unit are provided as a pair coupled one-to-one with each other, and a plurality of pairs equivalent to the number of policies is provided.

In the above arrangement, since it is only necessary to provide one quality determination unit for one queue, the process of the dynamic quality decision can be simplified.

In a packet transmission apparatus according to a fourteenth aspect of the present invention, the priority is a threshold for available capacity of a relevant queue, the discard decision unit determines whether or not to discard the received packet based on the threshold for the relevant queue and the available capacity.

Owing to the above arrangement, the discard decision can be carried out easily and correctly.

In a packet transmission apparatus according to a fifteenth aspect of the present invention, the quality determination unit refers to the accumulated used amount of the relevant flow and dynamically determines the priority.

In a packet transmission apparatus according to a sixteenth aspect of the present invention, the quality determination unit refers to the continuous time of the relevant flow and dynamically determines the priority.

In the above arrangement, by adapting so that the service quality is lowered when the accumulated used amount or continuous time has exceeded a certain range, it is possible to ensure the fairness of the transmission by preventing the transmission from being monopolized by a specific user. To the contrary, when the certain range has been exceeded, when the service quality is raised, it is possible to serve a heavy user (for example, a good client) advantageously.

In a packet transmission apparatus according to a seventeenth aspect of the present invention, the quality determination unit dynamically determines the priority using a random number.

Here, when confliction on a transmission path becomes heavy, sometimes packets of a flow are discarded consecutively. However, owing to the above arrangement, since the priority is determined at random, such a discard can be prevented and the burst traffic can be dispersed. Also, from a different point of view, it is possible to prevent such a state that the packets of the entire flow are discarded simultaneously from occurring.

In a packet transmission apparatus according to an eighteenth aspect of the present invention, the quality determination unit refers to the number of active flows and dynamically determines the priority.

In the arrangement as described above, by adapting so that, when the number of the active flows has exceeded the certain range, the service quality is lowered, it is possible to protect a user who has started the transmission later and to prevent the transmission from being monopolized by an earlier user. As a result, the fairness of the transmission is ensured. To the contrary, by adapting so that, when the certain range has been exceeded, the service quality is raised, the quality provided to the earlier user can be maintained. It is possible to prevent such a state as described below from occurring. That is, for example, when an earlier user is receiving images, quality of the images being received by the earlier user are suddenly lowered due to a fact that a later user has started transmission even when the earlier user does nothing.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a traffic conditioner according to Embodiment 1 of the present invention;

FIG. 2 is a block diagram of a flow control unit of Embodiment 1;

FIG. 3 is a block diagram of a priority control mechanism according to Embodiment 2 of the present invention;

FIG. 4 is a block diagram of the flow control unit of Embodiment 1;

FIG. 5 is a block diagram of a flow control unit in Modification 1 of the present invention;

FIG. 6 is a block diagram of a flow control unit in Modification 2 of the present invention;

FIG. 7 is a block diagram a flow control unit in Modification 3 of the present invention;

FIG. 8 is a block diagram of a packet transmission apparatus according to Embodiment 3 of the present invention;

FIG. 9 is a block diagram of a packet shaper of Embodiment 3;

FIG. 10 is a block diagram of the flow control unit of Embodiment 3;

FIG. 11 is a block diagram of a packet transmission apparatus according to Embodiment 4 of the present invention;

FIG. 12 is a block diagram of a packet transmission apparatus according to Embodiment 5 of the present invention;

FIG. 13 is a diagram showing a system using a packet transmission apparatus according to Embodiment 6 of the present invention;

FIG. 14 is a diagram showing an example of a network system adopting a packet transmission apparatus according to Embodiment 7 of the present invention;

FIG. 15 is a block diagram of the packet transmission apparatus of Embodiment 7;

FIG. 16 is a flowchart of the packet transmission apparatus of Embodiment 7;

FIG. 17 is a diagram showing a configuration of a flow control table of Embodiment 7;

FIG. 18 is a diagram showing a configuration of a first table of Embodiment 7;

FIG. 19 is a flowchart of a first quality determination unit of Embodiment 7;

FIG. 20 is a diagram showing a configuration of a second table of Embodiment 7;

FIG. 21 is a flowchart of a second quality determination unit of Embodiment 7;

FIG. 22 is a flowchart of a third quality determination unit of Embodiment 7;

FIGS. 23(a)-(d) are diagrams, respectively, showing a state of a fourth table of Embodiment 7;

FIG. 24 is a flowchart of a fourth quality determination unit of Embodiment 7;

FIGS. 25(a)-(b) are diagrams showing an application of the fourth table of Embodiment 7;

FIG. 26 is a diagram illustrating a DiffServ architecture;

FIG. 27 is a block diagram showing a conventional traffic conditioner;

FIG. 28 is a block diagram of a conventional priority control mechanism;

FIG. 29 is a block diagram of a conventional shaper;

FIG. 30 is a diagram showing an RSVP; and

FIG. 31 is a block diagram of a conventional router.

### DETAILED DESCRIPTION OF THE PREFERRED EMBODIMENTS

Now, referring to the drawings, embodiments of the present invention will be described below.

(Embodiment 1)

Embodiment 1 relates to a traffic conditioner used as an input interface of an edge node for monitoring the packets flowing into the DS domain

Hereinafter, for simple depiction, a description will be made while taking an example of the case in which two classes, i.e., AF class (high priority) and other than the AF class (low priority) are included. However, Embodiment 1 is also applicable to a case, which has three or more classes.

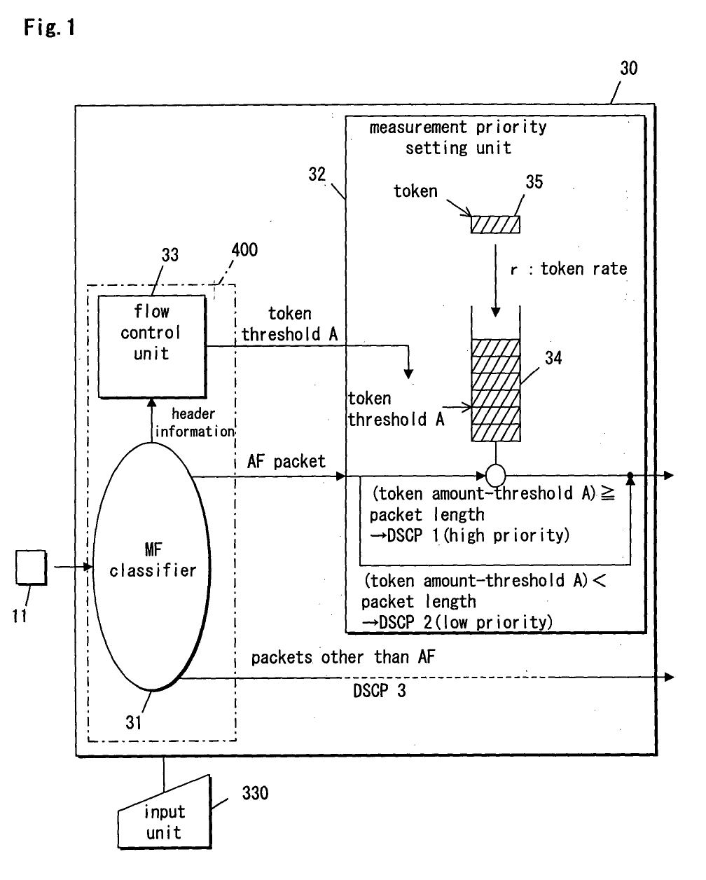

FIG. 1 is a block diagram of a traffic conditioner according to Embodiment 1 of the present invention. As shown in FIG. 1, the traffic conditioner 30 has the following elements.

A measurement priority setting unit 32 is for measuring the token and setting the priority of a packet 11. The measurement priority setting unit 32 has a token buffer 34 in which tokens 35 are accumulated at a predetermined rate of r.

An MF classifier 31 inputs the packet 11; and outputs packets with high priority (AF class) to the measurement priority setting unit 32 and outputs packets with low priority (other than the AF class) out of the traffic conditioner 30.

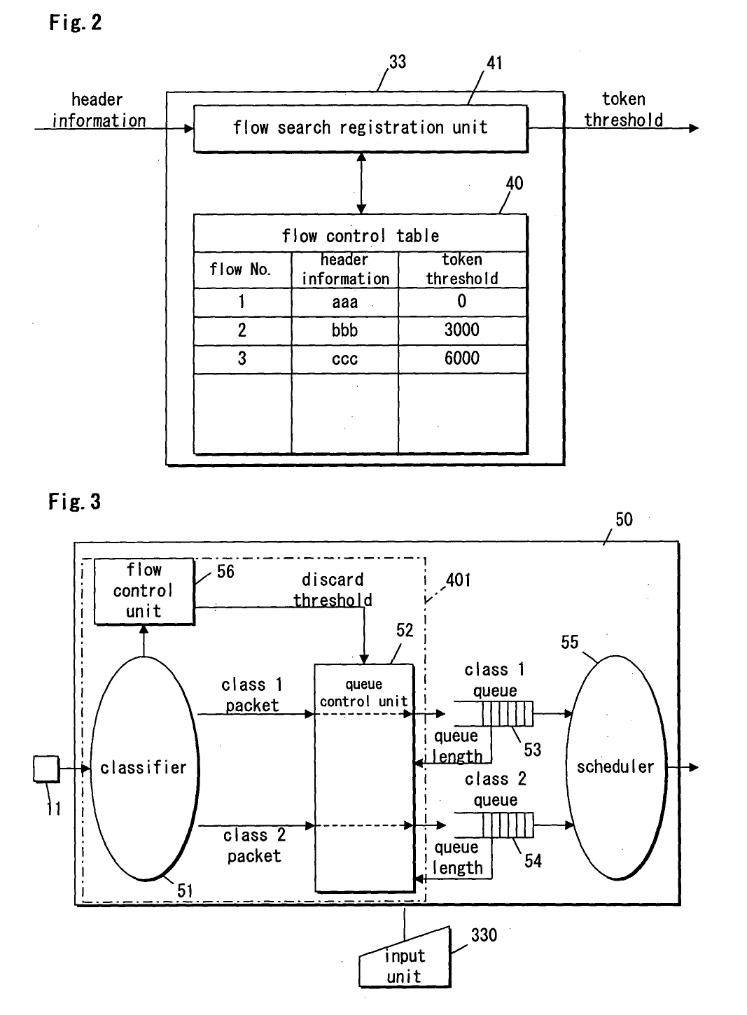

As shown in FIG. 2, a flow control unit 33 includes a flow control table 40 for holding token parameters based on the respective flows and a flow search registration unit 41 for retrieving certain data from the table 40 and registering certain data to the table 40. The flow control table 40 is equivalent to a flow control information storage unit.

According to Embodiment 1, the table 40 has three fields, i.e., flow No., header information and token threshold; and controls the data for each flow. The token threshold is a value equivalent to a token parameter. As for the token parameter, in addition to the above, a coefficient, which multiplies the token amount and the like, are included.

As shown in FIG. 1, when the packet 11 is input, the MF classifier 31 outputs header information thereof to a flow control unit 33 as flow information.

When the header information is input from the MF classifier 31, the flow control unit 33 outputs a token threshold A of a flow corresponding to the header information to the measurement priority setting unit 32 using the flow search registration unit 41 and the flow control table 40.

When the packet 11 (AF packet) is input from the MF classifier 31, the measurement priority setting unit 32 compares the packet length thereof with the token amount, which is accumulated in a token buffer 34 when the packet 11 is input.

The measurement priority setting unit 32 compares a value, which is obtained by subtracting a token threshold A obtained from the flow control unit 33 from the token amount of the token buffer 34 (token modified with a token parameter input from the flow control unit 33), with the packet length of the packet 11.

That is, when (present token amount of the token buffer 34−token threshold A)>=packet length, the measurement priority setting unit 32 determines that the packet 11 is within the guaranteed band; and gives the packet 11 the high priority mark (DSCP1) and outputs the packet 11.

Contrarily, if (present token amount of the token buffer 34−token threshold A)<packet length, the measurement priority setting unit 32 determines that the packet 11 has exceeded the guaranteed band; and gives the packet 11 the low priority mark (DSCP2) and outputs the packet 11.

If (present token amount of the token buffer 34−token threshold A)=packet length, irrespective of the above, it may be adapted so that it is determined that the packet 11 has exceeded the guaranteed band; and is given the low priority mark (DSCP2) for possible output.

As shown in FIG. 1, a pre-processing unit 400 according to Embodiment 1 includes the flow control unit 33 and the MF classifier 31.

As shown in FIG. 2, the flow control unit 33 gives smaller token thresholds to the flow that has started earlier in order.

For example, in the case where three flows of flow A, flow B and flow C have started transmission in this order, the flow control unit 33 allots these flows so that token thresholds Ta, Th and Tc result in Ta<Th<Tc.

In the example shown in FIG. 2, since the transmission has started in the order of flow No.1, flow No.2, and flow No.3, the token thresholds thereof result in “0,” “3000” and “6000”, respectively, in that order.

As for the flow of which a packet has not arrived for a certain period of time, the flow control unit 33 deletes the entry thereof from the flow control table 40.

Owing to this arrangement, since the flow that has started earlier obtains the token more easily, the flow that has started first is given DSCP1 (high priority mark) with priority.

Even under such a situation that the packets of DSCP2 are discarded at an occurrence of confliction on the network, as for the flow that has started earlier and is within the guaranteed band, the packets are not discarded. It is possible to prevent the packets of each flow from being discarded at confliction. As a result, in the case of image transmission, it is possible to prevent the entirety of images from being deteriorated simultaneously.

As described above, the traffic conditioner according to Embodiment 1 can provide the following packet transmission.

That is, in a network which performs QoS assurance, when a plurality of flows (including packets with the same priority) shares an guaranteed band, a difference is given between the priority of the packets belongs to a flow and the priority of the packets belong to another flow.

More particularly, a packet belongs to a flow of which the transmission start time is earlier is given a higher priority than that of a packet belongs to a flow of which the transmission start time is later on the in order of arrival basis based on the transmission start time of the flow.

Accordingly, a packet belongs to a flow of which the transmission start time is later is discarded earlier than a packet belongs to a flow of which the transmission start time is earlier.

As shown in FIG. 1, the measurement priority setting unit 32 is shared by a plurality of flows. Here, it is conceivable that a plurality of measurement priority setting units 32 equivalent to the number of flows is provided. However, if this arrangement is adopted, the load of the system resources becomes larger.

In Embodiment 1, taking the above problem into consideration, as shown in FIG. 2, each flow has only a value of token threshold separately, thereby the following are achieved as a set. That is, the processing of the flow is different from each other and the load of the system resources is reduced.

Furthermore, in the above embodiment, it may be adapted so that the priority becomes higher on the in reverse order of arrival basis based on the transmission start time of the flow; or, the priority is given at random; or, the priority is given based on the number of active flows at the transmission start point of the flow.

It may be arranged so that an input unit 330 including a key set, etc., is provided, and when an input is given by a user through the input unit 330, the priority of the present flow is excluded from the objects of dynamic decision and fixed to a certain value (for example, a maximum or minimum value, etc.) using the input as a trigger.

(Embodiment 2)

Embodiment 2 relates to a priority control mechanism used as an output interface of the core nodes and the edge nodes. The priority control mechanism classifies the packet 11 based on the DSCP marked by an edge node, and performs transfer processing (queuing, scheduling) based on the DSCP.

Hereinafter, for simple depiction, as identical to Embodiment 1, a case in which two classes are included will be described. However, by increasing the number of queues, etc., Embodiment 2 is applicable in the same way as the case in which three or more classes are included.

FIG. 3 is a block diagram showing a priority control mechanism according to Embodiment 2 of the present invention. As shown in FIG. 3, the priority control mechanism 50 has the following elements.

The priority control mechanism 50 has a plurality of queues 53 and 54 provided based on the priority of the classes (in the second embodiment, two classes) of the packet 11. A packet of class 1 is inserted into the queue 53 and a packet of class 2 is inserted into the queue 54. Of course, when the discard conditions (which will be described later) are met, the packet is discarded without being inserted into either queue.

The classifier 51 inputs the packet 11 and classifies the packet into class 1 or class 2 based on the priority.

The queue control unit 52 inputs the packet classified by the classifier 51 and inputs the packet into either queue 53 or 54 unless the discard conditions with respect to the packet are met.

The scheduler 55 takes out the packets from the queues 53 and 54 in order in accordance with the algorithm such as PQ or WRR and outputs the packets outside of the priority control mechanism 50.

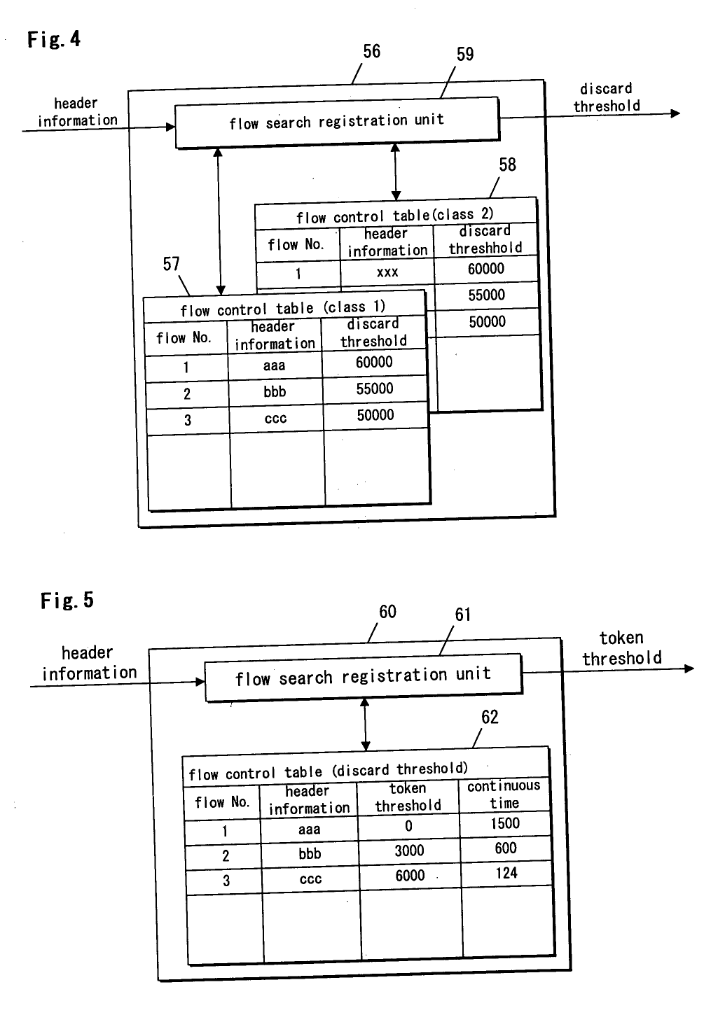

A flow control unit 56 has a configuration extremely close to that of the flow control unit 33 of Embodiment 1. That is, as shown in FIG. 4, the flow control unit 56 has flow control tables 57 and 58 and a flow search registration memory 59 for retrieving certain data from these tables 57 and 58 and registering certain data to the tables 57 and 58. These tables 57 and 58 hold discard thresholds for each flow.

In Embodiment 2, the pre-processing unit 401 includes the classifier 51, the queue control unit 52 and the flow control unit 56.

Here, in Embodiment 2, the flow control tables 57 and 58 are provided for each class. However, a single table will do when it is adapted to prevent information from being mixed.

Also, according to Embodiment 2, the tables 57 and 58 have three fields, i.e., flow No., header information and discard threshold; and control the data based on the flow. The discard threshold is a value that is equivalent to a discard parameter. As for the discard parameter, in addition to the above, a coefficient, which multiplies the queue length, and the like, are included.

When header information (equivalent to flow information) is input from the classifier 51, the flow control unit 56 outputs a discard threshold of the flow corresponding to the header information to the queue control unit 52 using the flow search registration memory 59 and the flow control tables 57 and 58.

The queue control unit 52 determines whether the packet should be inserted into the queue or should be discarded based on the following discard conditions using the present queue length of a class corresponding to the packet received from the classifier 51 and the discard threshold received from the flow control unit 56.

That is, when the (present queue length+packet length)>the discard threshold, the packet is discarded. When the (present queue length+packet length)<=the discard threshold, the packet is inserted into the queue of the relevant class.

The flow control unit 56 gives, as shown in FIG. 4, a larger discard threshold to be discarded to the flow that has started earlier in order.

For example, in the case where three flows of flow X, flow Y and flow Z have started transmission in that order, the flow control unit allots values to these flows, respectively, so that the discarded thresholds Tx, Ty and Tz result in Tx>Ty>Tz.

In the example shown in FIG. 4, the flow No.1 has started the transmission first based on the flow control table 57 which controls the class 1, and then, the flow No.2 and the flow No.3 follow in that order. Accordingly, the discard thresholds become smaller as “60000,” “55000” and “50000” in that order.

As for the flow of which a packet has not arrived for a certain period of time, the flow control unit 56 deletes the entries thereof from the flow control tables 57 and 58.

Owing to this arrangement, since the flow that has started earlier is hardly discarded, the flow that has started earlier is inserted into the queue earlier and is subjected to the service by the scheduler.

Even when the rate to be serviced by the scheduler at confliction of the network is reduced and packets are accumulated in the queue, as for the packet of the flow, which has started earlier and is within the guaranteed band, since the packet is inserted into the queue with priority, the packets are not discarded.

As arranged as described above, it is possible to prevent the packets of each flow from being discarded at confliction. As a result, in the case of image transmission, it is possible to prevent the entirety of images from being deteriorated at the same time.

As shown in FIG. 3, the queue control unit 52 is shared by a plurality of flows. Here, it is possible that a plurality of queue control units 52 equivalent to the number of flows is provided. However, when this arrangement is adopted, load of the system resources becomes larger.

In Embodiment 2, taking the above problem into consideration, as shown in FIG. 4, each flow has only a value of the discard threshold separately, thereby the following are achieved as a set. That is, the processing of the flow is made to be different from each other and the load of the system resources is reduced.

Furthermore, in the above embodiment, it may be adapted so that the priority become higher on the in reverse order of arrival basis based on the transmission start time of the flow; or, the priority is given at random; or, the priority is given based on the number of active flows at the transmission start point of the flow.

Furthermore, it may be arranged so that an input unit 330 comprised of a key set, etc., is provided, and when an input is given by a user through the input unit 330, using the input as a trigger, the priority of the present flow is excluded from the objects of dynamic decision and fixed to a certain value (for example, a maximum or minimum value, etc.)

(Modification 1)

Modifications of Embodiments 1 and 2 will be described below. The following modifications 1 through 3 are modification of the flow control unit 33 shown in FIG. 2 in Embodiment 1 and modification of the flow control unit 56 in Embodiment 2, respectively. By replacing the “token threshold” in Embodiment 1 with the “discard threshold” in Embodiment 2, modification is applicable in the same manner.

Accordingly, to avoid duplication of the description, hereinafter, description of Embodiment 1 will only be made and description of Embodiment 2 will be omitted.

As shown in FIG. 5, in a flow control unit 60 according to Modification 1, a token threshold (discard threshold in Embodiment 2) of a flow of which transmission has been continued longer than a certain period of time is changed so that the flow thereof becomes disadvantageous.

That is, a new field of “continuous time” is added to the flow control table 62 in the flow control unit 60 to measure the continuous time from a point when the relevant flow has started with the flow control unit 60.

As for a flow of which continuous time has exceeded a certain period of time, the originally set token threshold is changed to a value larger than the present largest token threshold in the flow control table 62. As a result, the flow is handled disadvantageously.

For example, in the flow No.1 shown in FIG. 5, since the continuous time is too long, the token threshold thereof is changed from the present value “0” to a value larger than the largest token threshold (for example, “9000,” etc.)

Owing to this arrangement, the packets of the flow, which has exceeded a certain period of time, has the highest possibility to be marked DSCP2 (low priority). As a result, it is possible to prevent a flow, which is protected with priority on the in order of arrival basis, from occupying the band for a long time.

(Modification 2)

In Modification 2, the “continuous time” of Modification 1 is replaced with the “accumulated used amount.”

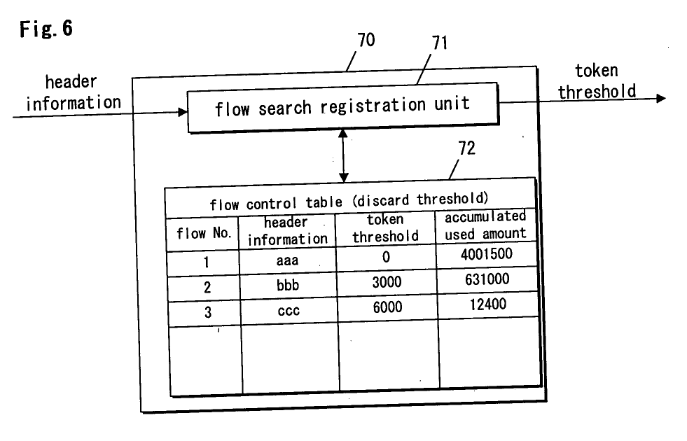

As shown in FIG. 6, in the flow control unit 70 according to Modification 2, the token threshold (discard threshold in Embodiment 2) of a flow of which the accumulated used amount has exceeded a certain value is changed so that the flow thereof becomes disadvantageous.

That is, a new field of the “accumulated used amount” is added to the flow control table 72 in the flow control unit 70 to measure the accumulated used amount from a point when a relevant flow has started with the flow control unit 70.

As for a flow of which the accumulated used amount has exceeded the certain value, the originally set token threshold is changed to a value larger than the present largest token threshold in the flow control table 72. As a result, the flow is handled disadvantageously.

For example, since the accumulated used amount of the flow No. 1 shown in FIG. 5 is too large, the token threshold thereof is changed from the present value “0” to a value (for example, “9000,” etc.) larger than the largest token threshold.

Owing to this arrangement, the packets of the flow, of which the accumulated used amount has exceeded the certain value, has the highest possibility to be marked DSCP2 (low priority). As a result, it is possible to prevent a flow, which is protected with priority on the in order of arrival basis, from occupying the band for a long time.

As described above, by controlling based on the amount, a flow, which requires a larger band, is controlled in a shorter period of time.

(Modification 3)

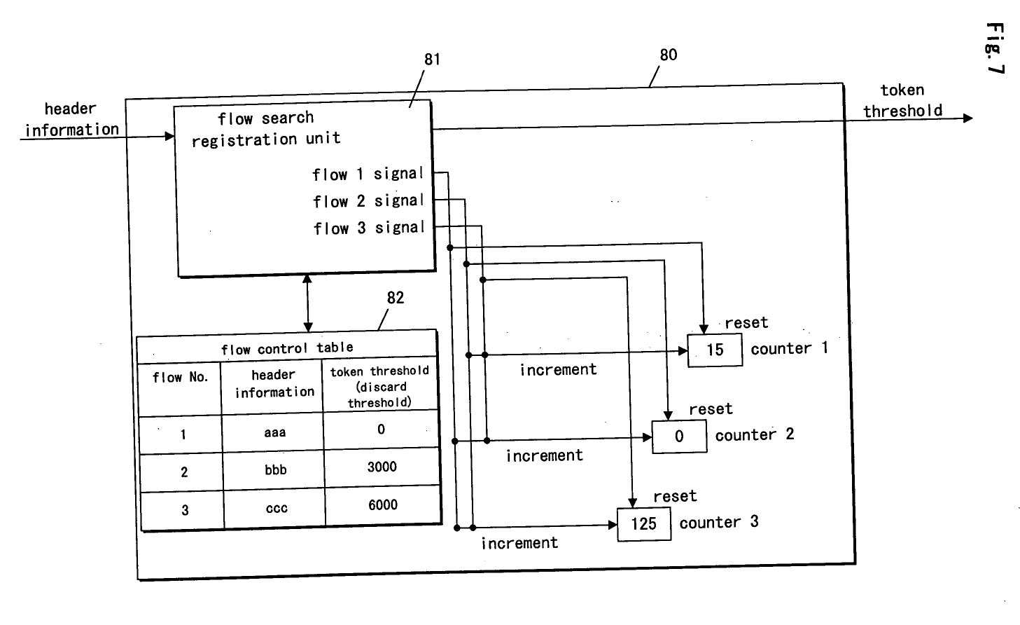

In Modification 3, as shown in FIG. 7, each flow is provided with a timer, respectively. Compared to a method which performs a terminate decision, since smaller hardware resources will do, a flow control unit 80 is adapted so that Modification 3 can be easily achieved for the hardware.

That is, the flow control unit 80 according to Modification 3 includes, in addition to a flow search registration unit 81 and a flow control table 82, counters 1, 2 and 3. These counters 1, 2 and 3 serve as a packet counter, respectively.

When a packet has arrived, the flow search registration unit 81 resets a packet counter, to which the packet is included, to 0, and changes the packet counters of other flows by 1 increment.

Owing to this arrangement, a counter of a flow, of which packets arrive successively, is reset to 0 each time a packet has arrived. On the other hand, the counter value of a flow, for which a packet does not arrive, is increased.

When a packet counter has reached a certain value, the flow search registration unit 81 determines that the flow thereof has completed and deletes the entry thereof from the flow control table 82.

Here, when controlling the flow using the software, it may be adapted so that each flow is provided with a timer respectively, and a flow, for which a packet has not arrived for a certain period of time, is determined as the flow having been completed and is discarded from the flow control table.

However, this arrangement is hardly incorporated into the hardware, because the number of flows may become considerably large. Because of limit of the capacity for the system resources, it is difficult to provide many timers.

According to Modification 3, by providing counters as described above, it is possible to reduce the load of the system resources. Additionally, the same processing as the case where many timers are provided can be achieved.

According to Embodiments 1 and 2 and the modifications thereof, the following effects can be obtained.

Even when available band is reduced due to confliction, it is possible to prevent the packets of each flow from being discarded. As a result, it is possible to control the transmission quality of each flow from being deteriorated.

When a plurality of image transmissions is carried out by using a minimum band assurance service in a transmission quality assurance network of the DiffServ system, even when available band is reduced due to confliction, it is possible to prevent the picture quality of the entire images from being deteriorated at the same time.

Irrespective of whether the DiffServ system is adopted or not, in an ordinary transmission quality assurance system, in the case that a plurality of image transmissions is carried out by using a service in which available band fluctuates, even when the available band is reduced due to confliction; it is possible to prevent the picture quality of the entire images from being deteriorated at the same time.

It is possible to prevent a flow, which is guaranteed with priority on the in order of arrival basis, from continuing to use a band for a long period of time.

It is possible to prevent a flow, which is guaranteed with priority on the in order of arrival basis, from continuing to use a large band for a long period of time.

Owing to the limitation based on the amount, a flow, which requires a larger band, is limited to a shorter period of time.

Compared with a method in which timers are provided for each flow to determine completion, since smaller hardware resources will do, it is easily corporated into the hardware.

The following Embodiments 3 through 6 relate mainly to a packet shaper.

(Embodiment 3)

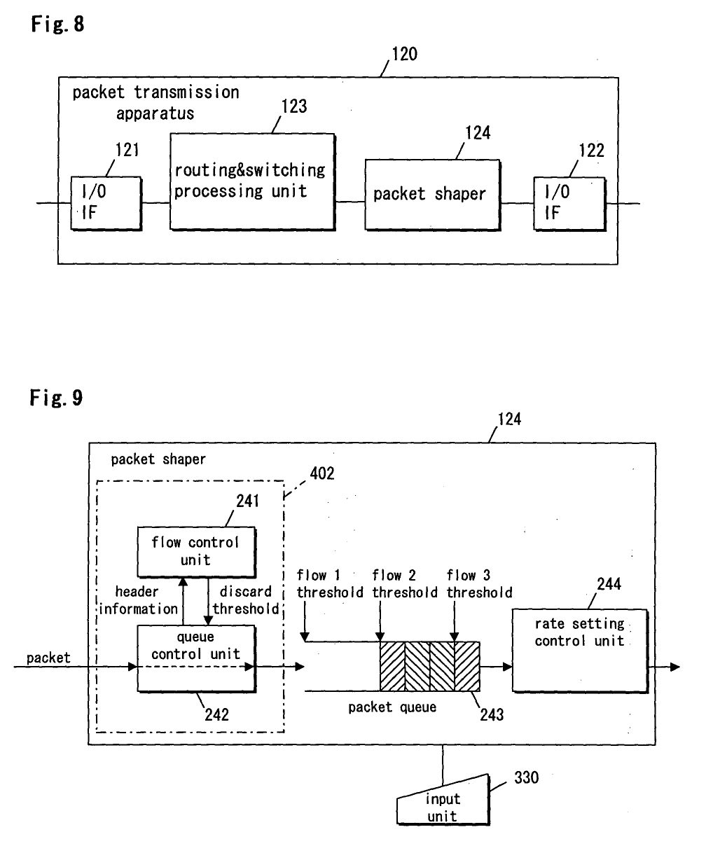

As shown in FIG. 8, a packet transmission apparatus 120 includes the following elements. First, two I/O interfaces 121 and 122 input and output packets, respectively.

A routing & switching processing unit 123 transfers packets from one I/O interface 121 to the other I/O interface 122 in the above I/O interfaces 121 and 122.

A packet shaper 124 is interposed between the routing & switching processing unit 123 and the other I/O interface 122, after shaping the same, outputs the packets, which are output by the routing & switching processing unit 123, to the other I/O interface 122.

Furthermore, as shown in FIG. 9, the packet shaper 124 includes the following elements. First, a packet queue 243 has a certain queue length, and stores packets temporarily.

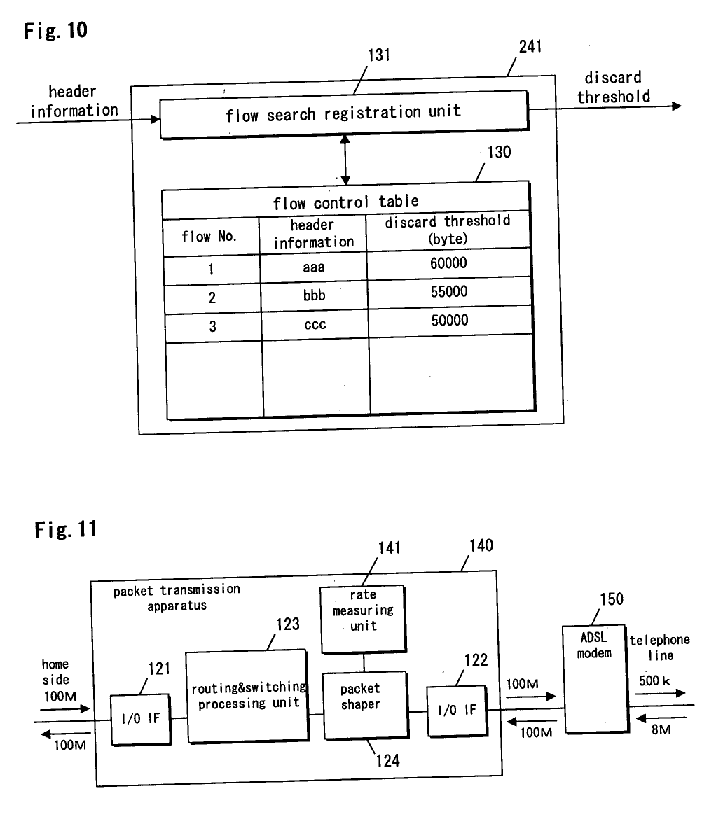

The flow control unit 241 has discard parameters, which are set for each flow. As shown in FIG. 10, the flow control unit 241 includes a flow control table 130 and a flow search registration unit 131, which retrieves certain data from the table 130 and registers a certain data into the table 130. The table 130 is equivalent to a flow control information storage unit. The table 130 is shared by each flow and holds discard thresholds for each flow.

According to Embodiment 3, the pre-processing unit 402 includes the flow control unit 241 and a queue control unit 242.

Also, according to Embodiment 3, the table has three fields; i.e., flow No., header information and discard threshold to control the data for each flow.

The discard threshold is equivalent to a value equivalent to the discard parameter. As for the discard parameter, in addition to the above, a coefficient for multiplying with queue length is available.

As shown in FIG. 9, the flow control unit 241 inputs header information (equivalent to flow information) of a packet received from the queue control unit 242.

Then, the flow search registration unit 131 searches flow control table 130. When a flow corresponding to the header information is found in the flow control table 130, a discard threshold of the flow corresponding to the header information is output to the queue control unit 242. When no such flow is found in the flow control table 130, after registering new header information to the flow control table 130, the discard threshold is output to the queue control unit 242.

The queue control unit 242 inputs the packet, refers to the discard parameters in the flow control unit 241 and inserts the packet into the packet queue 243 unless the discard conditions relevant to the packet are met. The discard conditions are determined based on the packet length of the packet, the queue length of the packet queue 243 and the discard parameter of the flow relevant to the packet.

The rate setting control unit 244 is adapted so as to output the packet from the packet queue 243 at a random rate.

The queue control unit 242 determines whether to insert the packet into the packet queue or to discard the same using the queue length of the present packet queue and the discard threshold received from the flow control unit 241 based on the following discard conditions.

That is, if the (present queue length+packet length)>the discard threshold, the packet is discarded. On the other hand, if the (present queue length+packet length) the discard threshold, the packet is inserted into a queue of the relevant class.

Here, as shown in FIG. 10, the flow control unit 241 gives a discard threshold earlier to a flow that has started earlier in order.

For example, in the case where the transmission of three flows of flow X, flow Y and flow Z has started in that order, the flow control unit 241 allots values so that the discard thresholds Tx, Ty and Tz of the these flows become as Tx>Ty>Tz.

Now, in the example shown in FIG. 10, the flow No.1 has started the transmission first, and the flow No.2 and the flow No. 3 follow in this order.

Accordingly, the discard thresholds of these become smaller as “60000,” “55000” and “50000” in this order.

As for a flow of which a packet has not arrived for a certain period of time, the flow control unit 241 deletes the entry thereof from the flow control table 130.

Owing to this arrangement, since the flow that has started earlier is hardly discarded, the flow that has started earlier is inserted into the queue with priority and output from the packet queue.

Owing to the above arrangement, in such a case where the rate of the output interface is larger than the rate of the input interface, even when confliction has occurred at the output interface, as for packets of the flow which have started earlier and are within the rate of the output interface, since the packets are inserted into the queue with priority and output after being shaped at the rate of the output interface, the packets are not discarded.

Without making a reservation, it is possible to control the packets of each flow from being discarded at confliction. As a result, in the case of image transmission, it is possible to control the entire images from being deteriorated at the same time.

Furthermore, the flow control unit 241 changes the discard parameters of a flow of which transmission continues longer than a certain period of time so that the flow thereof becomes disadvantageous, and changes discard parameters of a flow of which an accumulated used amount has exceeded a certain level so that the flow thereof becomes disadvantageous.

Owing to this arrangement, it is possible to prevent a band from being occupied by a specific flow and fairness in band usage is ensured.

Furthermore, in the above embodiment, it may be adapted so that priority becomes higher on the in reverse order of arrival basis based on the transmission start time of the flow; or, the priority is given at random; or, the priority is given based on the number of active flows at the transmission start point of the flow.

Furthermore, it may be arranged so that an input unit 330 comprised of a key set, etc., is provided, and when an input is given by a user through the input unit 330, using the input as a trigger, the priority of the present flow is excluded from the objects of dynamic decision and fixed to a certain value (for example, a maximum or minimum value, etc.)

(Embodiment 4) In the Case of ADSL

FIG. 11 is a block diagram of a packet transmission apparatus according to Embodiment 4 of the present invention. Embodiment 4 is an invention in which Embodiment 3 is applied to an ADSL. Accordingly, hereinafter, as for contents, which are the same as those in Embodiment 3, description thereof will be omitted.

As shown in FIG. 11, the packet transmission unit 140 according to Embodiment 4 includes a rate measuring unit 141 for measuring the maximum output rate of other I/O interface 122.

The rate setting control unit 244 of the packet shaper 124 is adapted so as to dynamically change the rate based on the maximum output rate measured by the rate measuring unit 141.

In the case of the ADSL, I/O interface at the home side is allotted 100 Mbps. On the other hand, an up rate of the ADSL is at most 500 kbps or so. When a transmission is carried out from a home to the outside, confliction occurs at an ADSL modem 150. Accordingly, the rate of the packet shaper 124 may be preferably set to 500 kbps.

Owing to this arrangement, confliction (indiscriminate discard of packets) will not occur near the ADSL modem 150. As described in Embodiment 3, a high priority flow of images within 500 kbps is protected on the in order of arrival basis. For example, even when three or more image flows of 200 kbps exist, the packets of two flows (equivalent to 400 kbps), which have started earlier, are protected with priority, and the packets of the image flow of the third flow or later are discarded. Accordingly, it is possible to prevent such a problem as the entire images from being deteriorated at the same time.

Here, the available transmission rate of the ADSL for each user varies depending on the distance from a station to the user's home. Therefore, according to Embodiment 4, the rate measuring unit 141 is provided, and after being installed, a transmission rate available for the home is measured. And a measured available transmission rate is set to the rate setting control unit 244 of the packet shaper 124.

Owing to this arrangement, while optimizing the transmission rate available for the ADSL which varies depending on the user, it is possible to prevent the packets of each flow from being discarded at confliction, and in the case of image transmission, it is possible to prevent the entire images from being deteriorated at the same time.

Here, the measuring steps by the rate measuring unit 141 are, for example, as described below. That is, a file transmission is made to a transmission unit at the station using a file transmission command of ftp, and the transmission rate is measured based on the transmission time.

(Embodiment 5) In the Case of HGW with Wireless Interface

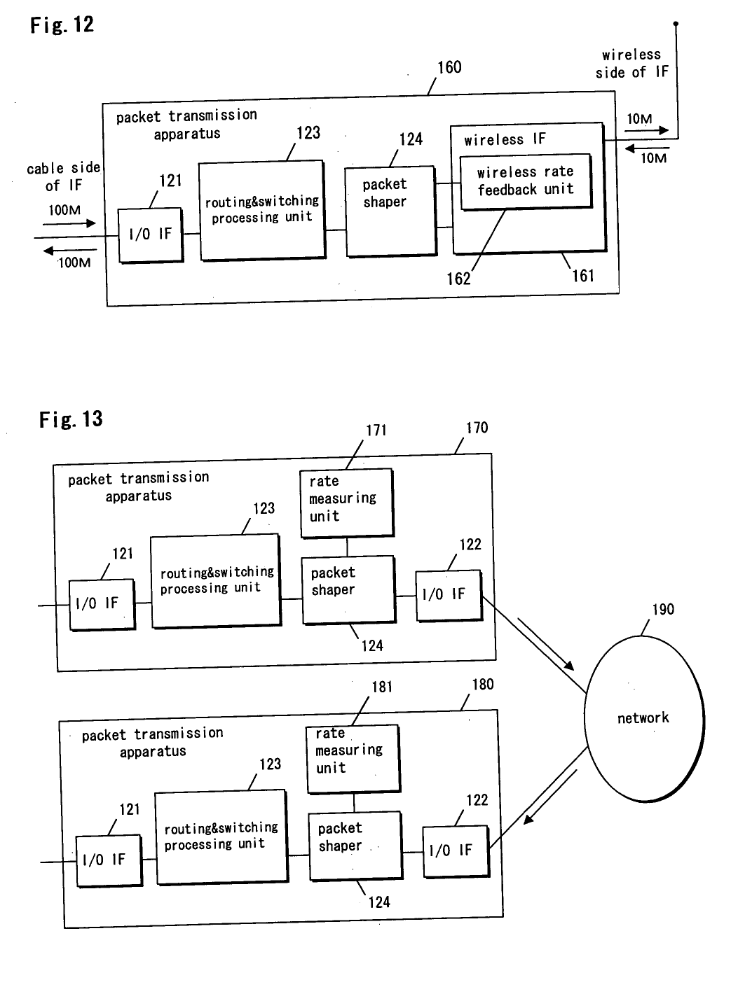

FIG. 12 is a block diagram showing a packet transmission apparatus according to Embodiment 5 of the present invention. Embodiment 5 is the same as Embodiment 3, which is applied to a home gateway (HGW) with a wireless interface. Hereinafter, as for contents, which are the same as those in Embodiment 3, description thereof will be omitted.

As shown in FIG. 12, a packet transmission apparatus 160 according to Embodiment 5 includes a wireless rate feedback unit 162 as a rate measuring unit that measures the maximum output rate of another I/O interface 161.

The rate setting control unit 244 of the packet shaper 124 is adapted so as to dynamically change the rate based on the maximum output rate, which is calculated by the wireless rate feedback unit 162.

In the example shown in FIG. 12, the cable I/O interface 121 is 100 Mbps; while the wireless interface is, in the case of 802.11a, 54 Mbps. Accordingly, when transmitting from a home to the outside, confliction may occur.

Therefore, the rate of the packet shaper 124 should be set to 54 Mbps; thereby, confliction (random discard of packets) near the wireless interface 161 is prevented from occurring.

As described in Embodiment 3, as for flows having the high priority within the range of 54 Mbps, they are protected on the in order of arrival basis. Accordingly, for example, even when 10 or more image flows of 6 Mbps flow, the packets of 9 flows, which have started earlier (equivalent to 54 Mbps), are protected, and the packets of the 10th or later image flows are discarded. Accordingly, it is possible to prevent the entire images from being deteriorated at the same time.

Furthermore, in the case of wireless, depending on the location of the receiver terminal or the obstacles, the available rate varies. For example, according to 802.11a, when a transmission has failed, the transmission rate is lowered by one step, and the data is transmitted again.

Therefore, according to Embodiment 5, the wireless rate feedback unit 161 is provided as the rate measuring unit, and the dynamically changing present transmission rate is set in the rate setting control unit 244 of the packet shaper 124.

Owing to this arrangement, even when the available transmission rate varies like in the case of wireless, while optimizing the capacity of the changing transmission path, it is possible to prevent the packets of each flow being discarded at confliction. Accordingly, in the case of image transmission, it is possible to prevent the entire images from being deteriorated at the same time.

(Embodiment 6) In the Case of VPN Router

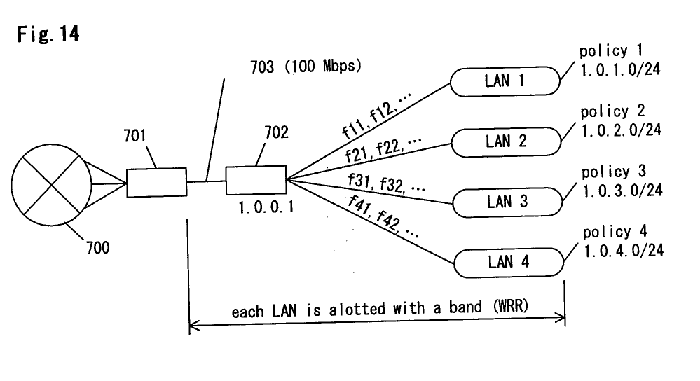

FIG. 13 is diagram showing a system using a packet transmission apparatus according to Embodiment 6 of the present invention. Embodiment 6 relates to an example in which packet transmission apparatus 170 and 180, which constitute a similar configuration in Embodiment 4 or 5, are connected to each other via a network 190. In particular, the packet transmission apparatus 170 and 180 are used as VPN routers.

Rate measuring units 171 and 181 in the packet transmission apparatus 170 and 180 according to Embodiment 6 perform transmission/reception of packets between the packet transmission apparatus 180 and 170 as the communication parties to measure the maximum rate between the packet transmission apparatus as the communication parties.

In the case of ordinary VPN, security is ensured by coding or the like. However, generally, the transmission rate is not ensured.

Therefore, according to Embodiment 6, the rate measuring unit 171 is provided to packet transmission apparatus 170 so as to perform transmission and reception of packets for measuring the rate with the rate measuring unit 181 of the coupled packet transmission apparatus 180 (VPN router). And based on the packet transmission rate at that time, presently available transmission rate is measured and is set to each rate setting control unit 244 of the respective packet shapers 124.

Owing to this arrangement, while optimizing the transmission rate available in VPN, it is possible to prevent packets of each flow from being discarded at confliction. Accordingly, in the case of image transmission, it is possible to prevent the entire images from being deteriorated at the same time.

According to Embodiments 3 through 6, in the packet transmission apparatus in a state that the (sum of the rate of the input interface) exceeds the (rate of the output interface), the following effects are obtained.

When a plurality of image flows exists and the sum of packets with high priority exceeds the rate of the output interface, it is possible to prevent the picture quality of the entire images being deteriorated and pre-signaling is not required. Accordingly, the cost of the entire system can be reduced.

Additionally, in an ADSL, wireless or VPN, while optimizing the available transmission rate, a plurality of image services can be provided.

(Embodiment 7)

Embodiment 7 relates to a technique that simply constitutes the techniques set forth in Embodiments 1 through 6, and furthermore, achieves the handling of a policy. First, before describing the particular constitution, several key concepts used in this specification will be described below. First, a transmitted packet includes a piece of header information and a data unit.

The “header information” is a part of a packet that includes destination information and protocol information other than a data unit. According to the TCP/IP, the “header information” is a value of a part of a field belongs to the IP header, TCP/UDP header, MAC header of lower hierarchy etc.

Furthermore, according to Embodiment 7, four field values of a sender port number and a receiver port number in the sender IP address, receiver IP address and TCP/UDP header are used as the header information for defining the “flow.”

That is, when these four field values coincide with each other, it is determined that they belong to a same flow. In other words, a “flow” is a set of packets of which four field values coincide with each other.

However, the flow may be defined by using a field other than the above (for example, protocol number, etc.) Furthermore, the protocol used in the invention is not limited to the TCP/IP. Any protocol, which uses a header based on the class of the receiver, may be used. A flow in the flows, of which a packet is now being transmitted, is, in particular, called an “active flow.”

Furthermore, the “queue” is a memory and memory controller that is a received packet, which is not discarded and inserted in the packet, and waits to be transmitted to the outside. According to Embodiment 7, the FIFO queue (transmission on the in order of arrival basis) is basically used. However, the LIFO queue (transmission on the in reverse order of arrival basis), etc., may be used.

The “queue length” is a term representing the amount of packets stored in the queue. According to Embodiment 7, for simple depiction, the number of packets is used as a unit. However, the number of bytes or number of bits, etc., of all packets inserted in the queue may be used.

The “queue ID” (QID) is an identifier uniquely given to these queues when two or more queues are included (four QDIs are provided in Embodiment 7).

The “queue length threshold” (QTH) is a value equivalent to the priority, which is uniquely allotted to each received packet. As described later, whether a received packet is discarded or not is decided by comparing the sizes of the queue length and the queue length threshold. According to Embodiment 7, a packet having a larger queue length threshold is hardly discarded and has a higher priority. However, unless the result is inconsistent, it may be adapted so that a packet having a larger queue length threshold is easily discarded.

The “set of service quality” is a set of flows which have the same policy. In the example shown in FIG. 14, flows f11 and f12, etc., relevant to LAN1 are included in the same set of service quality S1. Flows f21 and f22, etc., relevant to LAN2 have a policy different from that of the set of service quality S1, and are included in another set of service quality S2.

The “set of shared resources” is a set of service quality, which uses the same resources. In Embodiment 7, the resources are the queues.

The service quality herein indicates occupation ratio, occupation priority, etc., of the shared resources. For example, when a plurality of sets of service quality is included in the same shared resources, it is possible to make a difference in availability of the resources among these sets of service quality.

The “static quality decision” is to decide and apply a certain quality. For example, in the case of packets based on the VoIP, etc., it is always possible to allot a high quality thereto.

The “dynamic quality decision” is to decide quality in accordance with the situation. For example, when the quality should be varied in accordance with the behavior of a flow or another flow, the quality of this decision is used.

Then, while taking an example shown in FIG. 14, a preferred embodiment of the packet transmission apparatus according to the invention will be described.

FIG. 14 shows an example of a network system in which a packet transmission apparatus according to Embodiment 7 of the present invention is described.

Referring to FIG. 14, a network 700 is a large size external network such as, for example, the Internet. In the network 700, a packet transmission apparatus 701 according to Embodiment 7 is connected thereto; the left side of FIG. 14 is the up-stream side, and the right side thereof is the down-stream side. That is, the packet transmission apparatus 701 serves as a router that transmits packets along with the network 700 and a sub-element (switch 702 and others) connected thereto.

Furthermore, the downstream side of the packet transmission apparatus 701 is connected to a switch 702 via a transmission path 703 of 100 Mbps. In Embodiment 7, the switch 702 has an IP address (hereinafter, referred to simply as address) of “1.0.0.1.”

In the example shown in the figure, at the downstream side of the packet transmission apparatus 701, each LAN is allotted with a band, respectively, based on the WRR.

Under the switch 702, four LANs of LAN1 to LAN4 are connected thereto, these LAN1 to LAN4 have a specific policy of policy 1 to policy 4, respectively.

Specifically, the policy of the LAN1 means that “quality is raised each time when the accumulated used amount has increased by 100 Mbytes.” The address of the LAN1 is “1.0.1.0 to 1.0.1.24.” In the LAN1, flows f11, f12, etc., are transmitted. These flows f11, f12, etc., belong to the set of service quality S1.

Also, the policy 2 of the LAN2 means that “every time when 30 minutes of the continuous time has elapsed, the quality is lowered.” The address of the LAN2 is “1.0.2.0 to 1.0.2.24.” In the LAN2, flows f21, f22, etc., are transmitted. These flows f21, f22, etc., belong to the set of service quality S2.

Also, the policy 3 of the LAN3 means that “quality is determined at random.” The address of the LAN3 is “1.0.3.0 to 1.0.3.24.” In the LAN3, flows f31, f32, etc., are transmitted. These flows f31, f32, etc., belong to the set of service quality S3.

Furthermore, the policy 4 of the LAN4 means that “every time when the active flow has increased by 64, the quality of the active flow is lowered.” The address of the LAN4 is “1.0.4.0 to 1.0.4.24.” In the LAN4, flows f41, f42, etc., are transmitted. These flows f41, f42, etc., are included in the set of service quality S4.

As described above, these policies have a different dimension, respectively. Even when the respective transmission situations are likely to change in the same manner, in the respective LANs, generally, the change in quality thereof does not coincide with each other.

With the conventional art, it is difficult to dynamically change the quality because of such a different dimension, respectively, and reflecting the usage situation of the transmission resources.

However, according to the invention, the following will be demonstrated. In the above-described system, even when a plurality of flows f11, f12, f21, f22 and the like flow in a mixed manner through a shared transmission path 703, and these flows follow a different policy, respectively, it is possible that each policy is respected and is not interfered with each other and is handled independently.

In the above description, as shown in FIG. 14, for simple depiction, an example in which the LAN and the policy are coupled one to one is given. However, it is not always necessary that the policy be coupled with the LAN one to one. For example, a user, which follows a policy 1, and a user, which follows a policy 2, may be included in the LAN1. In such a case, the invention is applicable in the same manner.

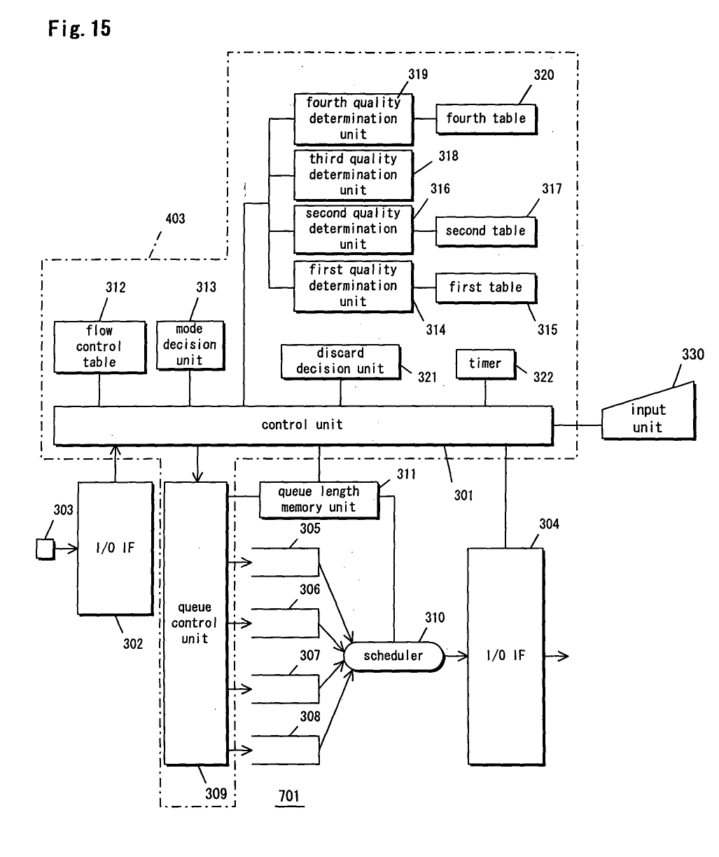

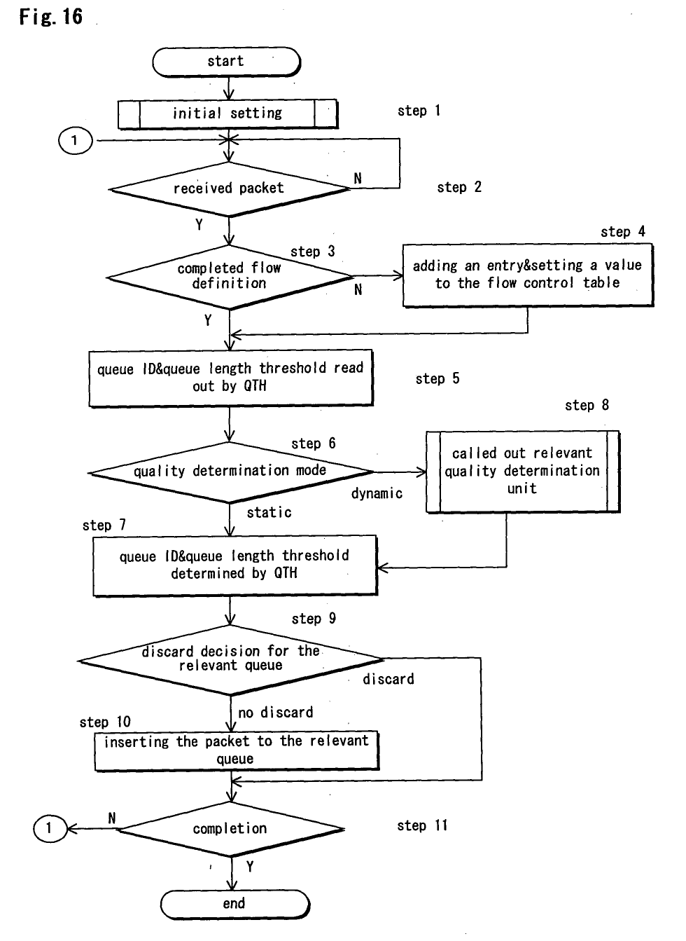

Next, referring to FIG. 15, elements in the packet transmission apparatus 701 according to Embodiment 7 will be described. In FIG. 15, a control unit 301 controls the elements shown in FIG. 15 in accordance with the flowchart shown in FIG. 16.

An I/O interface 302 is equivalent to a packet receiving unit for receiving a packet 303 from the outside.

According to Embodiment 7, four queues 305-308 are provided. Unless being discarded, the received packet is inserted into any one of these queues 305-308 by a queue control unit 309 that follows the instruction from the control unit 301. These queues 305-308 have a unique queue ID (QID), respectively, and are discriminated based on the queue ID.

The I/O interface 304 is equivalent to a packet transmission unit transmits the packet to the outside that is output from one of the queues 305-308 and received from a scheduler 310.

According to Embodiment 7, when packet transmission is available, the scheduler 310 selects a queue out of the queues 305-308 based on the WRR (Weighted Round Robin), and transmits a packet therefrom.

Since the scheduling algorithm of the scheduler 310 is optional, any one of WFQ (Weighted Fair Queuing) that controls the band of each queue based on the weight, PQ (Priority Queuing) that controls the priority, etc., transmits packets. The WFQ and the PQ may be combined with each other. When a single queue is used, the FIFO or LIFO may be simply used.

A queue length memory unit 311 includes a memory and the like and is arranged so as to store present queue length of the queues 305-308 and to read out the present queue length when instructed with the queue ID.

According to Embodiment 7, as described above, since the queue length is represented with a number of packets, the queue length is handled as below.

That is, when queue control unit 309 inserts a packet into any one of the queues 305-308, a relevant queue length in the queue lengths stored by the queue length memory unit 311 is increased by 1.

Contrarily, when the scheduler 310 outputs a packet from any one of the queues 305-308 to the I/O interface 304, a relevant queue length in the queue lengths stored by the queue length memory unit 311 is subtracted by 1.

A discard decision unit 321 compares the present queue length of the relevant queue and a queue length threshold QTH. When the queue length threshold QTH is larger than the present queue length, the discard decision unit 321 decides to discard the received packet; and if not, decides not to discard the same. A timer 322 measures the present time and notifies it to the control unit 301.

A flow control table 312 is equivalent to a flow control information storage unit. The flow control table 312 connects information defining a flow of a packet and information concerning the priority of the packet belongs to the flow and holds them. The information concerning the priority of the packet belongs to the flow of the flow control table 312 is configured so as to be used as the basis for static/dynamic decision.

As shown in FIG. 15, according to Embodiment 7, a pre-processing unit 403 includes the control unit 301, the queue control unit 309, the flow control table 312, a mode decision unit 313, first-fourth quality determination units 314, 316, 318 and 319, first, second and fourth tables 315, 317 and 320, the discard decision unit 321 and the timer 322.

Furthermore, it is arranged so that an input unit 330 comprised of a key set, etc., is provided, and when an input is given by a user through the input unit 330, using the input as a trigger, the priority of the present flow is excluded from the objects of dynamic decision and fixed to a certain value (for example, a maximum or minimum value, etc.)

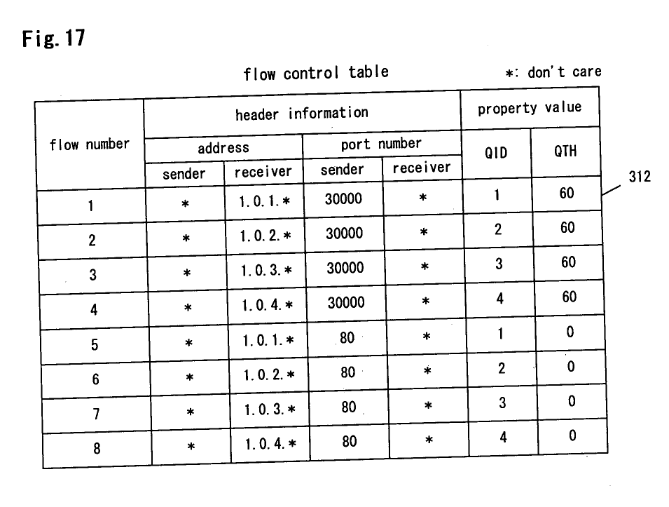

Next, referring to FIG. 17, the contents of the flow control table 312 will be described in detail.

As shown in FIG. 17, the flow control table 312 has three fields, i.e., flow number, header information and property value.

Flow numbers are integral numbers, which are uniquely given to each flow, equivalent to flow IDs. However, as for the flow IDs, they may not be the flow numbers. For example, a character string capable of distinguishing the flows without being mixed therein may be used.

The header information further has four fields, i.e., a sender address, receiver address, sender port number and receiver port number. According to Embodiment 7, a flow is defined as a set of packets of which four values coincide with each other. In accordance with this, the header information of the flow control table 312 has the above four values. When a protocol number is included in the definition on the flow, the protocol number should be included also in the header information of the flow control table 312.

The property value further has fields of queue ID (QID) and queue length threshold (QTH). These values are as defined above.

Particularly, the value of the QTH should be noted. For the flow numbers 1-4, QTH=60. The value is ordinal as the queue length threshold.

However, for the flow numbers 5-8, QTH=0. When the value is applied as it is for comparing the present queue length and the queue length threshold, even when the present queue length has some value, results in every packet being discarded.

That is, the queue length threshold of QTH=0 indicates an invalid priority. Furthermore, when the queue length threshold QTH indicates any effective priority, there is no case of QTH=0.

Therefore, in Embodiment 7, it is arranged so that, when the priority of a flow should be determined dynamically, QTH=0; on the other hand, when the priority of a flow should be determined statically, the QTH is set to a value other than 0.

That is, as for the packets relevant to the flow numbers 1-4, the priority thereof is determined statically (value of the flow control table 312 is as it is). On the other hand, as for the packets relevant to the flow numbers 5-8, the priority thereof is determined dynamically based on any one of the quality determination units 314, 316, 318 and 319 shown in FIG. 15.

Furthermore, the queue ID (QID) of the property value indicates to which queue the relevant flow (if not discarded) should be inserted. According to Embodiment 7, when QID=1, the queue 305 is used; likely when QID=2, 3 or 4, the queue 306, 307, 308 and 309 are used.

As shown in FIG. 15, first-fourth quality determination units 314, 316, 318 and 319 corresponding one to one to the queues 305, 306, 307 and 308, respectively, are provided thereto.

When the packet 303 arrives at the I/O interface 302, based on the above-described rule, the mode decision unit 313 shown in FIG. 15 receives the packet 303 from the control unit 301 and checks to which flow the packet 303 should belong to referring to the flow control table 312.

When the flow number is identified, the mode decision unit 313 checks the QTH of the relevant flow number as to whether the number is “0” or not. When the number is “0,” since the packet should be subjected to a dynamic decision, the mode decision unit 313 notifies a quality determination unit relevant to the QID of the flow number to the control unit 301.

When the number is not “0,” the mode decision unit 313 notifies that the QTH should be determined statically to the control unit 301.

In the above example, the value “0” that is invalid as the QTH is given just as an example. For example, a negative value may be set. In any case, setting of the values for the flow control table 312 in FIG. 17 and the algorithm, etc., for the quality determination units 314, 316, 318 and 319 should be completed at the initial setting of the packet transmission apparatus.

Now, referring to FIG. 16, the operation flow of the packet transmission apparatus according to Embodiment 7 will be described below. Detailed description of the quality determination units 314, 316, 318 and 319 will be described in detail later.

First, in Step 1 shown in FIG. 16, as described above, the control unit 301 sets values to the flow control table 312 and performs initial setting of the quality determination units 314, 316, 318 and 319.

Next, in Step 2, the control unit 301 waits for the packet 303 to arrive at the I/O interface 302. When the packet 303 has arrived at the I/O interface 302, the control unit 301 checks whether or not the flow relevant to the packet 303 is defined in the flow control table 312.

When the flow is not defined yet, in Step 4, an entry is added to the flow control table 312 and a value is set, and the process proceeds to Step 5. When the flow has been defined, the process proceeds to Step 5 immediately.

Next, in Step 5, the control unit 301 instructs the mode decision unit 313 to decide the mode. The mode decision unit 313 refers to the flow control table 312, and when the value of the QTH is the invalid value “0,” based on the above-described rule, the mode decision unit 313 determines that a dynamic decision should be made using the quality determination unit. When the value is valid, a static decision should be made. The result is notified to the control unit 301 (Step 6).

When the notice indicates that the static decision should be made, in Step 7, the control unit 301 determines to use the relevant QID and QTH of the flow control table 312.

On the other hand, when the notice indicates that the dynamic decision should be made, the control unit 301 calls out a relevant quality determination unit (Step 8). The called-out quality determination unit performs a processing in accordance with the policy and returns the QTH to the control unit 301; thereby the QID and QTH are determined.

Next, in Step 9, the control unit 301 makes the discard decision unit 321 determine whether or not the packet 303 should be discarded. When discarded, the process proceeds to Step 11 immediately. When it is not to be discarded, in Step 10, the control unit 301 transfers the packet 303 to the queue control unit 309 and indicates a queue ID to be inserted. Then, the queue control unit 309 inserts the packet 303 into the indicated queue (Step 10), and the process proceeds to Step 11.

In Step 11, after checking that the process is not completed, the control unit 301 makes the process return to Step 2. After that, the processes after Step 2 are repeated.

The scheduler 310 transfers packets from the queues 305-308 to the I/O interface 304 in order in accordance with the scheduling algorithm. The I/O interface 304 transmits the received packets to the outside.

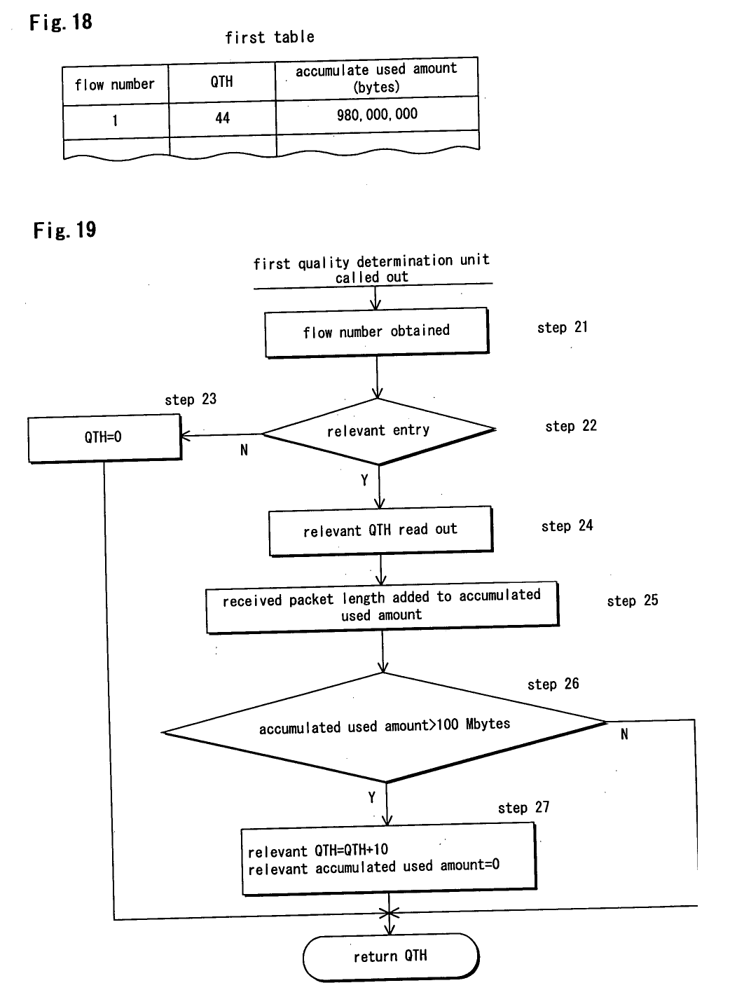

Next, the quality determination units 314, 316, 318 and 319 that perform the dynamic quality decision will be described below. First, referring to FIG. 18 and FIG. 19, the first quality determination unit 314 and the first table 315 will be described.

The first quality determination unit 314 and the first table 315 are for achieving the policy 1 (quality is raised each time when the accumulated used amount increases by 100 Mbytes) of the LAN1 shown in FIG. 14. The policy 1 is intended to be used on the metered rate basis. Accordingly, the more it is used the greater the service is raised.

As shown in FIG. 18, the first table 314 includes fields of flow number, QTH and accumulated used amount.

Here, the flow number is the same as the flow number of the flow control table 312. However, the queue length threshold QTH does not coincide with that of the flow control table 312, and is rewritten depending on the situation. Basically, the accumulated used amount is increased every time when a packet passes through.

When an initial setting is made, the policy 1 is used. That is, entries relevant to each flow included in the set of service quality S1, and each value is set up.

Then, when the control unit 301 calls out the first quality determination unit 314 in Step 8 shown in FIG. 16, the process shown in FIG. 19 is carried out.

First, in Step 21, the first quality determination unit 314 obtains a flow number from the control unit 301 and checks whether or not any entry relevant to the flow number is included in the first table 315 in Step 22.

If not, in Step 23, the first quality determination unit 314 sets “0” to the QTH, and returns the process to the control unit 301 and terminates the process. Then, the packet is discarded.

If any entry is found, in Step 24, the first quality determination unit 314 reads out a relevant QTH from the first table 315. In Step 25, the first quality determination unit 314 adds the received packet length to the accumulated used amount of the entry, and checks whether or not the accumulated used amount has exceeded 100 Mbytes in Step 26.

If not exceeded, the present QTH is returned to the control unit 301 and the process is terminated. If exceeded, the present QTH is increased by “10” in Step 27. The accumulated used amount is reset to “0,” the increased QTH is returned to the control unit 301 and the process is terminated.

Owing to this arrangement, dynamic decision of the quality based on the policy 1 (quality is raised each time when the accumulated used amount increases by 100 Mbytes) can be achieved.

It may be arranged so that a maximum threshold is set to the QTH, and when every QTH relevant to the flow number including the entry has reached the maximum threshold, the QTH is reset to the initial value (for example, 64, etc.)

Furthermore, a policy opposite to the policy 1 (the more use leads to a drop in quality) can be achieved easily by a minor change. For example, in place of increasing the QTH by “10” in Step 27, the QTH is reduced by “10.” This policy is based on a fixed charge system.

The above values are just for example. As a matter of course, these values may be changed appropriately.

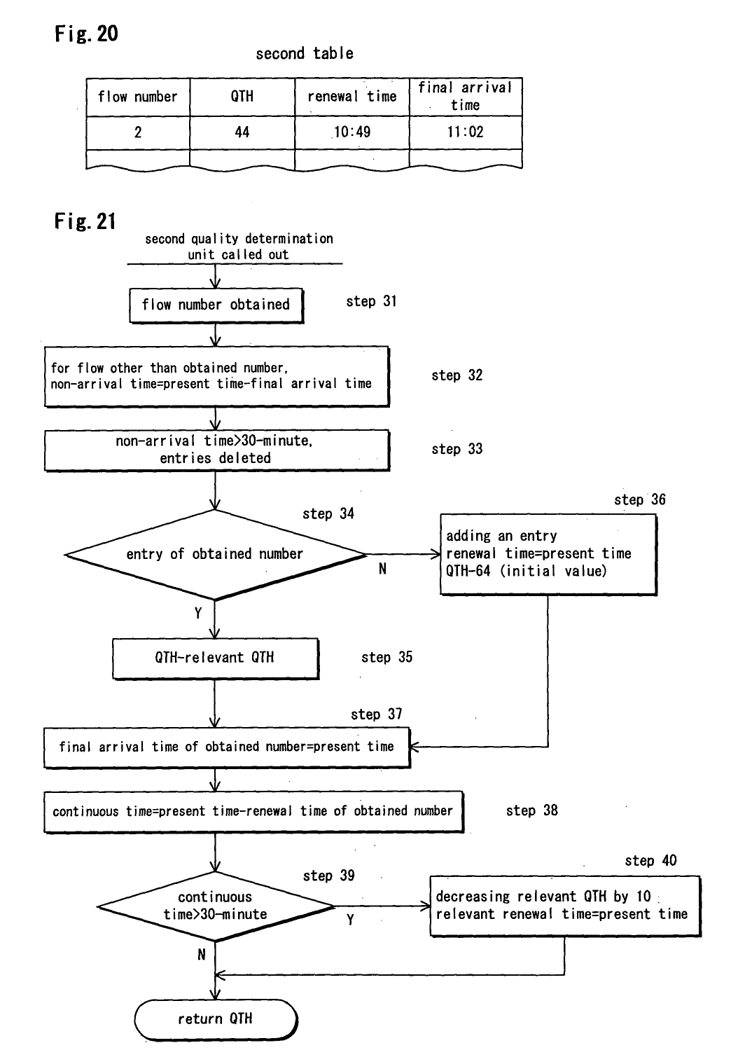

Next, referring to FIG. 20 and FIG. 21, the second quality determination unit 316 and the second table 317 shown in FIG. 15 will be described. These elements 316 and 317 are for achieving the policy 2 (quality is lowered each time when 30 minutes of continuous time has elapsed) of the LAN2 shown in FIG. 14. The policy 2 is suitable for, for example, a case where service such as VoIP, and TV telephone is provided on a fixed charge basis, and in the case of a long time transmission, the transmission quality is lowered as a penalty.

As shown in FIG. 20, the second table 317 includes four fields of flow number, QTH, renewal time, and final arrival time.

The flow number and QTH are the same as those in the first table 315 shown in FIG. 18. The renewal time means the time when the contents of a relevant entry have been changed. The final arrival time means the time when a packet in the entry has arrived last.

Unlike the first table 315, the second table 317 has no entry at the initial setting.

In Step 8 shown in FIG. 16, when the second quality determination unit 316 is called out, a process shown in FIG. 21 is carried out.

That is, in Step 31, the second quality determination unit 316 obtains a flow number from the control unit 301. In Step 32, non-arrival times of the flows, which have a number other than the above number and entry, are calculated. The non-arrival time is calculated using the following formula:

“Non-arrival time=present time−final arrival time.”

In Step 33, the second quality determination unit 316 deletes the entries of which non-arrival time exceeds 30 minutes. This process is for deleting the entries of the flows, which are not active flows.

In Step 34, the second quality determination unit 316 checks for the entry relevant to the obtained number. If not, in Step 36, the second quality determination unit 316 adds an entry and enters the present time into the field of the renewal time of the added entry, and sets “64” in the field of the QTH as the initial value. Then, the process proceeds to Step 37.

When the above entry is made, in Step 35, the second quality determination unit 316 sets the QTH of the entry to the return value QTH. Then, the process proceeds to Step 37.

In Step 37, the second quality determination unit 316 sets the present time to the field of the final arrival time of the obtained number or the added entry.

In Step 38, the second quality determination unit 316 calculates the continuous time (=present time−renewal time of the entry of the obtained number or added entry). In Step 39, the second quality determination unit 316 checks for any entry of which the continuous time has exceeded 30 minutes.

If any, in Step 40, the second quality determination unit 316 decreases the QTH of the entry by “10,” sets the present time in the field of the renewal time of the entry, and returns the return value QTH to the control unit 301. Then, the process is terminated.

On the contrary, if there is no entry, the second quality determination unit 316 returns the return value QTH to the control unit 301 as it is. Then, the process is terminated.

As described above, the second table 317 changes in an ever-changing manner. When the entry is short due to the limits of memory, it may be arranged so that the entry is not provided, and a safety value as the QTH (for example, 32, etc.) is returned to the control unit 301.

Furthermore, a policy opposite to the policy 2 (quality is raised at each time when the continuous time has elapsed by 30 minutes) is also available by a minor change. For example, in Step 40, in place of decreasing the QTH by “10,” the same is increased by “10.”

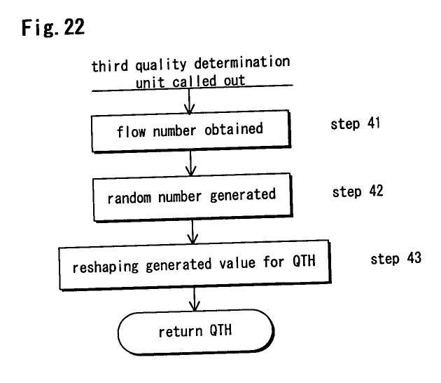

Next, referring to FIG. 22, the operation of the third quality determination unit 318 shown in FIG. 15 will be described. Unlike the other tables, the quality determination unit 318 does not include any table. Accordingly, the initial setting is not required.

The third quality determination unit 318 is for achieving the policy 3 (quality is determined at random).

That is, in Step 8 shown in FIG. 16, when the third quality determination unit 318 is called out by the control unit 301, the process shown in FIG. 22 is carried out.

First, in Step 41, the third quality determination unit 318 obtains a flow number, and then, generates a random number in Step 42.

Then, in Step 43, the third quality determination unit 318 reshapes the generated value so as to match the QTH, and generates a return value and returns the same to the control unit 301.

In the TCP, in order to ensure fairness in the flow, the RED technique, which has been described in the related art, is provided. This technique raises the discard probability of a packet in proportion to the average queue length. However, since

(1) it is necessary to calculate the average queue length each time when a packet has arrived; and

(2) it is necessary to calculate the discard probability based on the average queue length each time when a packet has arrived, the processing load is too heavy.

On the other hand, with the third quality determination unit 318, a processing virtually approximate to the RED can be obtained with a simple calculation.

That is, when a packet, which is included in a set of service quality S3 relevant to the policy 3, the third quality determination unit 318 allots a QTH at random.

Accordingly, the packet becomes easier to discard in proportion to the length of the queue length, while the packet avoids being discarded in inverse proportion to the length thereof. That is, appearance behavior is close to the RED.

For generating the random number, it is not necessary to calculate or obtain the queue length and average queue length. Accordingly, the processing load is not so heavy.

Furthermore, with the process of the third quality determination unit 318, compared to the case of a simple drop tail (a packet exceeding the queue length on the FIFO basis is discarded), since the distribution of the discarded packets is spread, it is possible to prevent the packets of a specific flow from being discarded intensively.

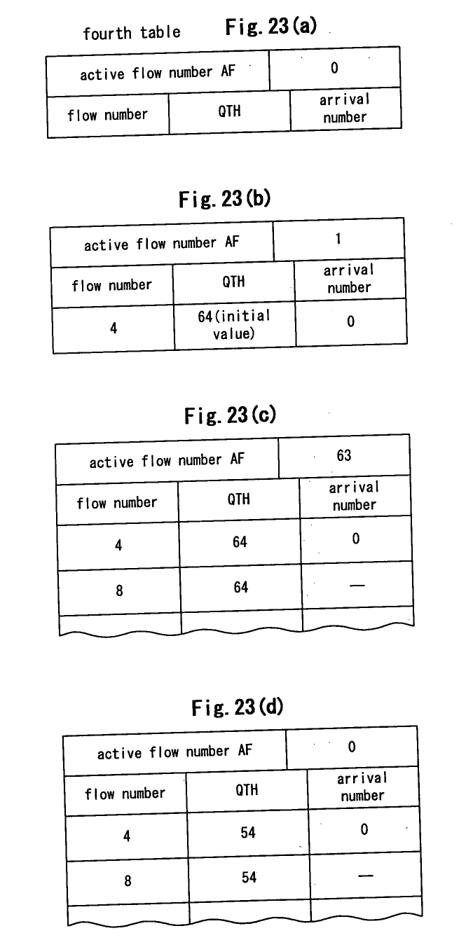

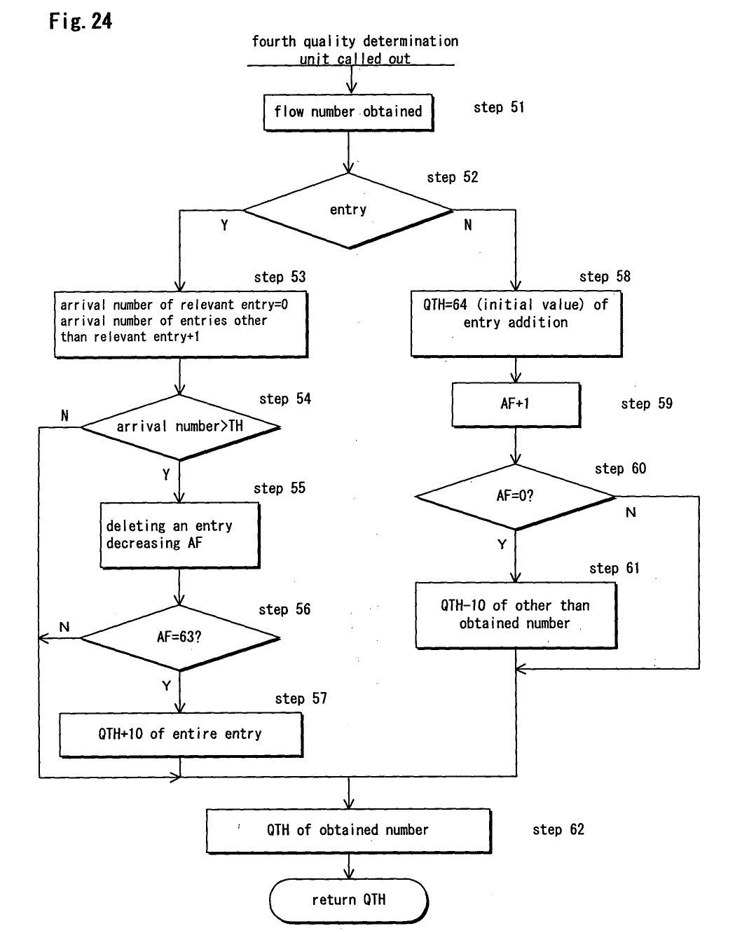

Next, referring to FIG. 23 and FIG. 24, the fourth quality determination unit 319 and the fourth table 320 will be described.

These elements 319 and 320 are for achieving the policy 4 (active flow quality is lowered each time when the active flow has increased by 64).

As shown in FIG. 23, the fourth table 320 has an active flow number, and three fields of flow number, QTH and number of arrivals for each entry. The flow number and the QTH are the same as those in the first table 315. In this example, the number of the arrival is set to “0” at the first arrival.

At the initial setting, as shown in FIG. 23(a), there is no entry, and accordingly, the number of active flows AF is “0.”

Basically, the AF increases by “1” each time when a packet of a set of service quality S4 of the policy 4, and when AF=64, the AF returns to AF=0. When AF=0, the AF becomes AF-1=63

Next, referring to FIG. 24, the operation of the fourth quality determination unit 319 will be described. First, in Step 51, the fourth quality determination unit 319 obtains a flow number from the control unit 301.

In Step 52, the fourth quality determination unit 319 searches the fourth table 320 to check for any entry having the obtained flow number.

If any entry is found, the process proceeds to Step 53. If no entry is found, the process proceeds to Step 58.

In Step 53, the fourth quality determination unit 319 resets the arrival number of the relevant entry to “0.” And the fourth quality determination unit 319 increases the arrival number of the entries other than the relevant entry by +1.

That is, in the fourth table 320, the flow of which the arrival number is closer to “0” (i.e., smaller) is the more active flow.

In Step 54, the fourth quality determination unit 319 checks for any arrival number exceeding a certain threshold TH.

If any, in Step 55, the fourth quality determination unit 319 deletes the relevant entry and the process proceeds to Step 56. If none, the process proceeds to Step 62.

In Step 56, the fourth quality determination unit 319 checks if the AF is “63.” If not, the process proceeds to Step 62. If the AF is “63,” in Step 57, the fourth quality determination unit 319 adds “10” to the QTH of each entry, and the process proceeds to Step 62.

In Step 62, the fourth quality determination unit 319 sets the QTH of the flow which has obtained the number to the return value QTH, and returns the same to the control unit 301, and the process is terminated.

On the other hand, if no entry is found in Step 52, the fourth quality determination unit 319 adds an entry, and sets the QTH of the added entry as the initial value (64) in Step 58. Since one active flow has increased, the fourth quality determination unit 319 adds “1” to the AF in Step 59, and checks whether or not the AF is “0” in Step 60.

Here, when the AF is AF=63, and when the AF is added by “1” in Step 59, in accordance with the above-described rule, the AF becomes AF=0. Then, the process proceeds to Step 62, and as described above, the QTH of the obtained number is returned to the control unit 301, and the process is terminated.

In Step 60, when the AF is not “0,” the QTH of the numbers other than the obtained number are lowered by “10,” and the process proceeds to Step 62. This means that a band for transmitting a new flow is allotted.

Next, referring to FIG. 23, an example of transition of the fourth table 320 will be described. At the initial setting, as shown in FIG. 23(a), there is no entry, and AF is

When a first flow has arrived, as shown in FIG. 23(b), the AF becomes AF=1, and the initial value (64) is set to the QTH.

After that, when the flows are added successively, a point when the AF becomes AF=63 is as shown in FIG. 23(c). And after that, when a 64th flow has arrived, as shown in FIG. 23(d), the AF is reset to “0,” and the QTH of the entries relevant to the flows other than the arrived flow are reduced by “10.”

FIG. 23 and FIG. 24 show only an example. Embodiment 7 may be widely modified. For example, in order to prevent the flows from being deleted too frequently, a larger arrival number may be set. Also, in Step 54, the process may be made to proceed to Step 62 immediately from Step 55.

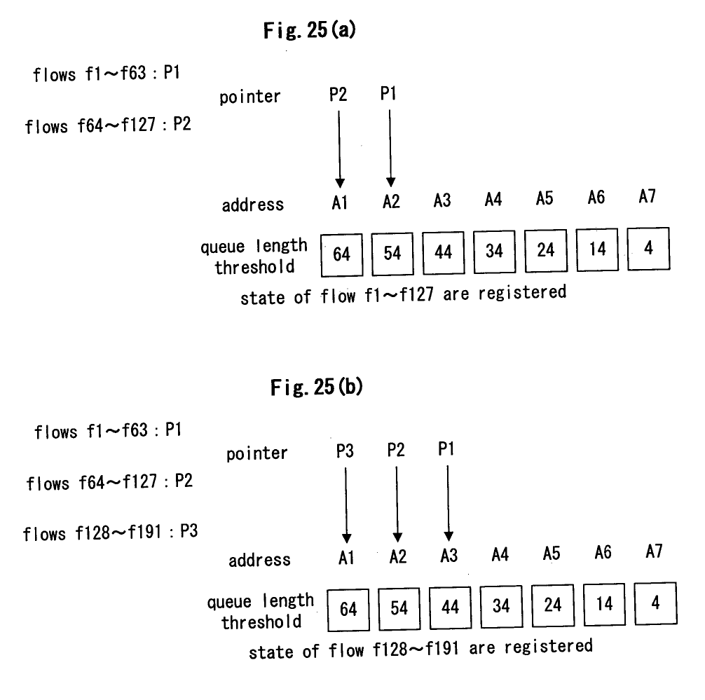

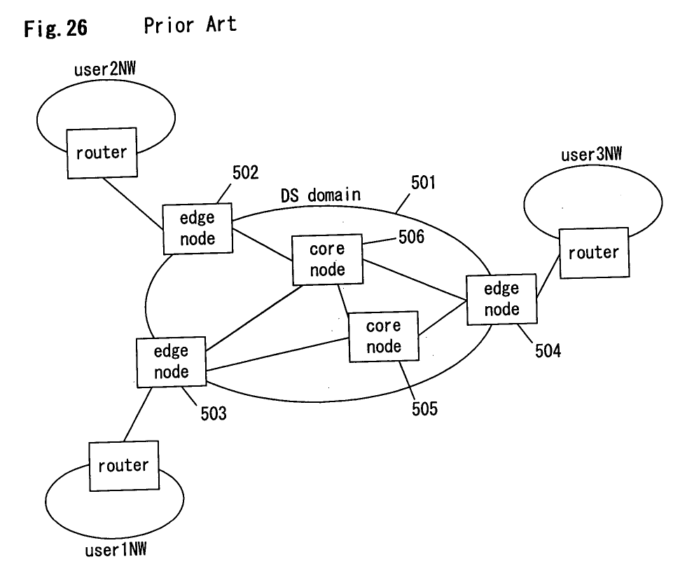

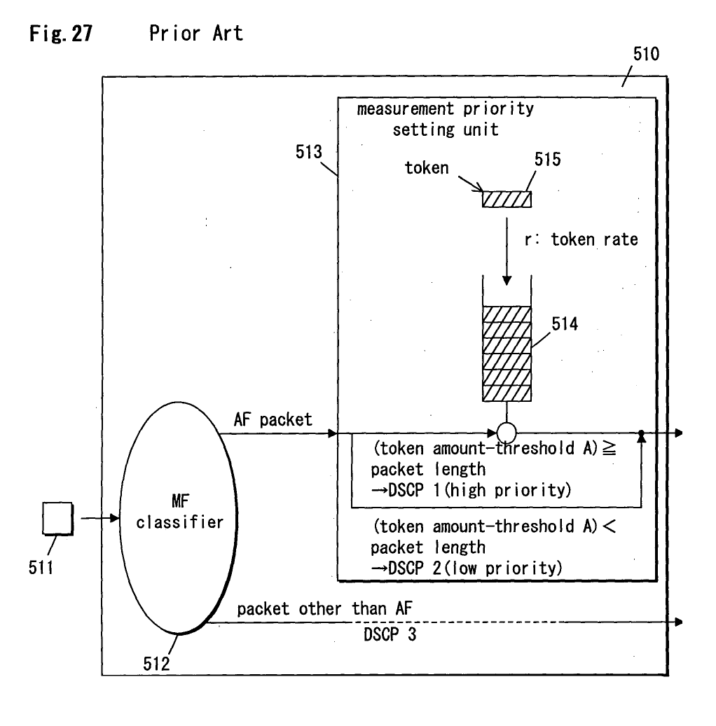

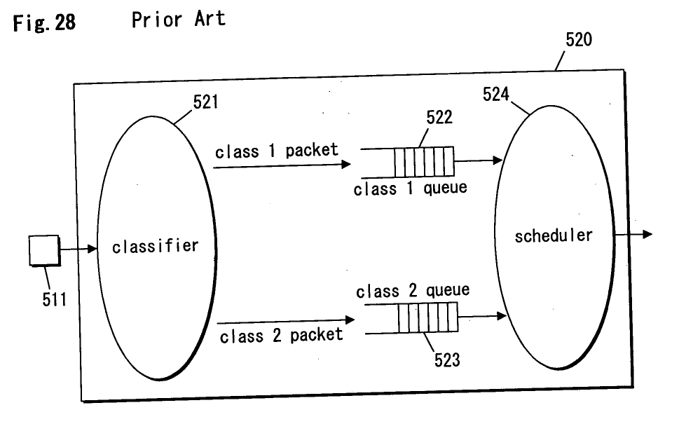

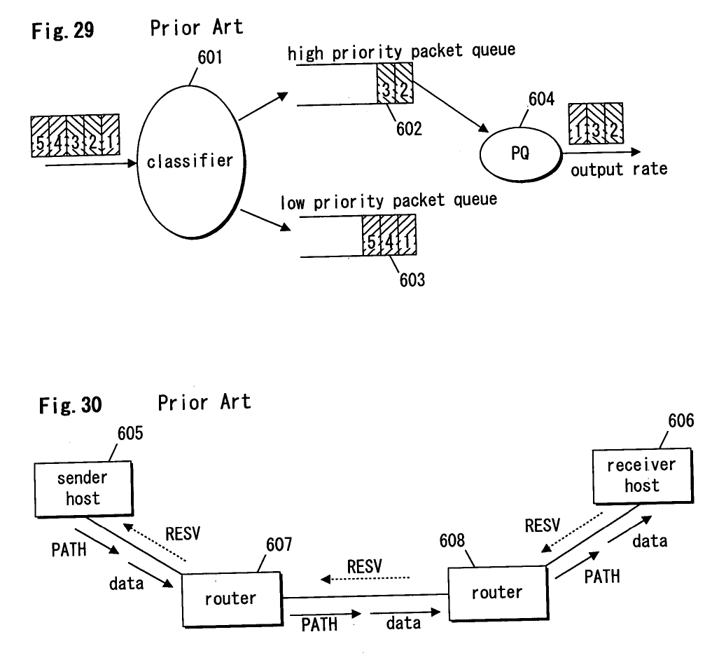

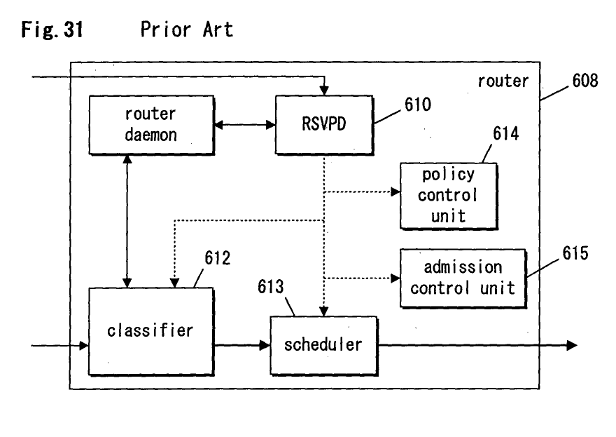

According to the above example, as for the QTH, when the minimum value is 4, only 7 options of 64, 54, 44, 34, 24, 14 and 4 are available. Here, as shown in FIG. 25(a), in the field of the QTH in the fourth table 20, pointers P1, P2, etc., may be inserted. And the entity of the QTH may be stored in memory address different from that of the field of the QTH, and the entity of the QTH may be represented by the pointers P1, P2, etc.

By adopting this arrangement, the increase and decrease of the QTH can be represented only by shifting the objects pointed by the pointers P1, P2, etc., thereby the process can be carried out swiftly and simply. When number of flows is increased, as shown in FIG. 25(b), only such a simple operation of the pointers as a pointer P3 being added will suffice.

With the process as described above, it is possible to achieve the policy 4 (quality of the active flow is lowered each time when the active flow has increased by 64).

According to Embodiment 7, even when flows of packets following various policies flow in a mixed manner, packet transmission in which each policy is respected can be carried out.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A packet transmission apparatus comprising a pre-processing unit configured so as to dynamically determine the priority of a packet belongs to a flow based on a specific policy,
wherein said pre-processing unit comprises:
a flow control information storage unit that correlates and holds information defining a flow of a packet and information concerning the priority of the packet belongs to the flow.

2. The packet transmission apparatus according to claim 1,
wherein said pre-processing unit dynamically determines the priority of the packet belongs to the flow on the in order of arrival basis based on the transmission start time of the flow.

3. The packet transmission apparatus according to claim 1,
wherein said pre-processing unit dynamically determines the priority of the packet belongs to the flow on the in reverse order of arrival basis based on the transmission start time of the flow.

4. The packet transmission apparatus according to claim 1,
wherein said pre-processing unit dynamically determines the priority of the packet belongs to the flow using a random number.

5. The packet transmission apparatus according to claim 1,
wherein said pre-processing unit dynamically determines the priority of the packet belongs to the flow based on the number of active flows at a transmission start point of the flow.

6. The packet transmission apparatus according to claim 1,
wherein, when the transmission of the flow is continued, said pre-processing unit changes the priority of the packet belongs to the flow.

7. The packet transmission apparatus according to claim 6,
wherein, when the transmission continuous time of the flow meets certain conditions, said pre-processing unit lowers the priority of the packet belongs to the flow.

8. The packet transmission apparatus according to claim 6,
wherein, when the packet transmission amount meets certain conditions, said pre-processing unit lowers the priority of the packet belongs to the flow.

9. The packet transmission apparatus according to claim 1,
further comprising an input unit for receiving user input,
wherein, when a user input is given from said input unit, said pre-processing unit changes the priority of a packet belongs to a present flow.

10. The packet transmission apparatus according to claim 9,
wherein, when a user input is given from said input unit, said pre-processing unit fixes the priority of a packet belongs to a present flow.

11. The packet transmission apparatus according to claim 10,
wherein, when a user input is given from said input unit, said pre-processing unit makes the priority of a packet belongs to a present flow higher than the present priority.

12. The packet transmission apparatus according to claim 10,
wherein, when a user input is given from said input unit, said pre-processing unit makes the priority of a packet belongs to a present flow lower than the present priority.

13. A packet transmission method that performs QoS guarantee, comprising:
in the case where a plurality of flows including packets having the same priority shares a guaranteed band,
handling these flows while making a difference between the priority of the packets belongs to at least one flow in these flows and the priority of the packets belong to the flows different from the one flow in these flows.

14. The packet transmission method according to claim 13,
wherein the difference in the priority is made on the in order of arrival basis based on the transmission start time of the flows.

15. The packet transmission method according to claim 13,
wherein the difference in the priority is made on the in reverse order of arrival basis based on the transmission start time of the flows.

16. The packet transmission method according to claim 13,
wherein, when the sum of the bands of a plurality of flows including packets having the same priority exceeds the guaranteed band shared by these flows, these flows are handled on the in order of arrival basis based on the transmission start time of the flows so that a packet belongs to a flow having the earlier transmission start time is given with the priority higher than a packet belongs to a flow having the later transmission start time.

17. The packet transmission method according to claim 13,
wherein, when the sum of the bands of a plurality of flows including packets having the same priority exceeds the guaranteed band shared by these flows, these flows are handled on the in reverse order of arrival basis based on the transmission start time of the flows so that a packet belongs to a flow having the later transmission start time is given priority higher than a packet belongs to a flow having the earlier transmission start time.

18. The packet transmission method according to claim 13,
wherein, when the sum of the bands of a plurality of flows including packets having the same priority exceeds the guaranteed band shared by these flows, a packet belongs to a flow having a later transmission start time is discarded earlier than a packet belongs to a flow having an earlier transmission start time on the in order of arrival basis based on the transmission start time.

19. The packet transmission method according to claim 13,
wherein, when transmission of a flow starts, the priority of the flow is determined by using a random number.

20. The packet transmission method according to claim 13,
wherein, the priority of a flow is determined based on the number of active flows at a point of transmission start of the flow.

21. A traffic conditioner, comprising:
a measurement priority setting unit operable to measure a token and to set the priority of a packet;
an MF classifier operable to input packets and to output packets having high priority to said measurement priority setting unit and outputs packets of low priority to the outside; and
a flow control unit operable to hold token parameters for each flow,
wherein said flow control unit inputs flow information of a packet from said MF classifier and outputs a token parameter corresponding to the flow information to said measurement priority setting unit;
wherein said measurement priority setting unit compares a token which is modified by a token parameter input from said flow control unit with the packet length of the packet, and sets the priority of the packet based on a comparison result.

22. The traffic conditioner according to claim 21,
wherein said measurement priority setting unit is shared by a plurality of flows.

23. The traffic conditioner according to claim 21,
wherein the token parameter is a token threshold which is subtracted from the token in modification by said measurement priority setting unit, and the flow information is the header information of the packet.

24. The traffic conditioner according to claim 21,
wherein said flow control unit sets the token parameter so that a flow of which transmission has started earlier becomes advantageous on the in order of arrival basis based on the transmission start time of the flows.

25. The traffic conditioner according to claim 21,
wherein said flow control unit sets the token parameter so that a flow of which transmission has started later becomes advantageous on the in reverse order of arrival basis based on the transmission start time of the flows.

26. The traffic conditioner according to claim 21,
wherein said flow control unit changes the token parameter of a flow of which transmission has continued longer than a certain period of time so that the flow becomes disadvantageous.

27. The traffic conditioner according to claim 21,
wherein said flow control unit changes the token parameter of a flow of which the accumulated used amount has exceeded a certain amount so that the flow becomes disadvantageous.

28. The traffic conditioner according to claim 21,
wherein said flow control unit has a packet counter for each flow, resets the packet counter of a relevant flow to 0 when a packet has arrived, increases the packet counters of flows other than that flow by 1, and terminates the control of a flow of which the packet counter has exceeded a certain value.

29. A priority control mechanism, comprising:
a plurality of queues provided for each class of the priorities of packets;
a classifier operable to input the packets to classify the packets in accordance with the priorities
a queue control unit that inputs the packets classified by said classifier and, unless the discard conditions regarding the packets are met, inserts the packets into any of said plurality of queues; and
a flow control unit that holds the discard parameters for each flow,
wherein said flow control unit inputs flow information of the packets from said classifier and outputs a discard parameter corresponding to the flow information to said queue control unit,
wherein the discard conditions are determined based on a packet length of a packet, a queue length of a queue relevant to the packet, and a discard parameter of a flow relevant to the packet.

30. The priority control mechanism according to claim 29,
wherein the discard conditions indicate that the packet is discarded, when the sum of the packet length of a packet and the queue length of the queue relevant to the packet is larger than the discard parameter.

31. The priority control mechanism according to claim 29,
wherein said queue control unit is shared by a plurality of flows.

32. The priority control mechanism according to claim 29,
wherein said flow control unit sets the discard parameter so that a flow of which transmission has started earlier becomes advantageous on the in order of arrival basis based on the transmission start time of the flows.

33. The priority control mechanism according to claim 29,
wherein said flow control unit sets the discard parameter so that a flow of which transmission has started later becomes advantageous on the in reverse order of arrival basis based on the transmission start time of the flows.

34. The priority control mechanism according to claim 29,
wherein said flow control unit changes the discard parameter of a flow of which transmission has continued longer than a certain period of time so that the flow becomes disadvantageous.

35. The priority control mechanism according to claim 29,
wherein said flow control unit changes the discard parameter of a flow of which the accumulated used amount has exceeded a certain amount so that the flow becomes disadvantageous.

36. The priority control mechanism according to claim 29,
wherein said flow control unit has a packet counter for each flow, resets the packet counter of a relevant flow to 0 each time when a packet has arrived, increases the packet counters of flows other than that flow by 1, and terminates the control of a flow of which the packet counter has exceeded a certain value.

37. A packet shaper comprising:
a packet queue operable to accumulate packets,
wherein, when a plurality of flows, which are accumulated in said packet queue and includes packets with the same priority, exists, the flows are handled while a difference is given between the priority of a packet belongs to at least one flow in these flows and the priorities of the packets belong to the flows different from the one flow in these flows.

38. The packet shaper according to claim 37,
wherein the difference in the priority is made based on the in order of arrival basis based on the transmission start time of the flows.

39. The packet shaper according to claim 37,
wherein the difference in the priority is made based on the in reverse order of arrival basis based on the transmission start time of the flows.

40. The packet shaper according to claim 37,
wherein the difference in the priority is made based on using a random number.

41. The packet shaper according to claim 37,
wherein, when the sum of the bands of a plurality of flows including packets having the same priority exceeds the output rate of the packet shaper, these flows are handled on the in order of arrival basis based on the transmission start time of the flows so that the priority of a packet belongs to a flow having the earlier transmission start time is higher than the priority of a packet belongs to a flow having the later transmission start time.

42. The packet shaper according to claim 37,
wherein, when the sum of the bands of a plurality of flows including packets having the same priority exceeds the output rate of the packet shaper, these flows are handled on the in order of arrival basis based on the transmission start time of the flows so that a packet belongs to a flow having the later transmission start time is discarded earlier than a packet belongs to a flow having the earlier transmission start time.

43. A packet shaper, comprising:
a packet queue operable to accumulate packets;
a rate setting control unit operable to output the packets from said packet queue;
a flow control unit operable to hold discard parameters, which is set for each flow; and
a queue control unit operable to refer to the discard parameters of said flow control unit and, unless the discard conditions relevant to a packet are met to insert the packet into said packet queue,
wherein the discard conditions are determined based on a packet length of the packet, a queue length of said packet queue and the discard parameter of the flow relevant to the packet.

44. The packet shaper according to claim 43,
wherein the discard conditions indicate that the packet is discarded, when the sum of the packet length of the packet and the queue length of the queue relevant to the packet is larger than the discard parameter.

45. The packet shaper according to claim 43,
wherein said packet shaper control unit is shared by a plurality of flows.

46. The packet shaper according to claim 43,
wherein said flow control unit sets the discard parameter so that a flow of which transmission has started earlier becomes advantageous on the in order of arrival basis based on the transmission start time of the flows.

47. The packet shaper according to claim 43,
wherein said flow control unit sets the discard parameter so that a flow of which transmission has started later becomes advantageous on the in reverse order of arrival basis based on the transmission start time of the flows.

48. The packet shaper according to claim 43,
wherein said flow control unit sets the discard parameter by using a random number.

49. The packet shaper according to claim 43,
wherein said flow control unit changes the discard parameter of a flow of which transmission has continued longer than a certain period of time so that the flow becomes disadvantageous.

50. The packet shaper according to claim 43,
wherein said flow control unit changes the discard parameter of a flow of which the accumulated used amount has exceeded a certain amount so that the flow becomes disadvantageous.

51. A packet transmission apparatus, comprising:
a plurality of 110 interfaces operable to input and to output packets;
a routing/switching processing unit operable to transfer packets from one I/O interface in said plurality of I/O interfaces to another I/O interface in said plurality of I/O interfaces; and
a packet shaper set forth in claim 37 interposed between said routing/switching processing unit and said another I/O interface, which performs a shaping of packets output from said routing/switching processing unit and outputs the packets shaped by said packet shaper to said another I/O interface.

52. The packet transmission apparatus according to claim 51, further comprising:
a rate measuring unit operable to measure a maximum output rate of said another I/O interface,
wherein said rate setting control unit of said packet shaper dynamically changes the rate based on the maximum output rate measured by said rate measuring unit.

53. The packet transmission apparatus according to claim 51,
wherein said rate measuring unit performs transmission and reception of packets with a packet transmission apparatus of a communication partner and measures a maximum rate between the packet transmission apparatus of the communication partner and itself.

54. A packet transmission apparatus, comprising:
a plurality of I/O interfaces operable to input and to output packets;
a routing/switching processing unit that transfers packets from one I/O interface in said plurality of I/O interfaces to another I/O interface in said plurality of I/O interfaces; and
a packet shaper set forth in claim 43 interposed between the said routing/switching processing unit and said another I/O interface, which performs a shaping of packets output from said routing/switching processing unit and outputs packets shaped by said packet shaper to said another I/O interface.

55. The packet transmission apparatus according to claim 54, further comprising:
a rate measuring unit operable to measure a maximum output rate of said another I/O interface,
wherein said rate setting control unit of said packet shaper dynamically changes the rate based on the maximum output rate measured by said rate measuring unit.

56. The packet transmission apparatus according to claim 54,
wherein said rate measuring unit performs transmission and reception of packets with a packet transmission apparatus of a communication partner and measures a maximum rate between the packet transmission apparatus of the communication partner and itself.

57. A packet transmission apparatus, comprising:
a packet receiving unit operable to receive packets from the outside;
a discard decision unit operable to decide whether or not to discard the received packets;
a queue into which the packets decided not to be discarded by said discard decision unit are inserted in order;
a packet transmission unit operable to transmit the packets output from said queue to the outside
a flow control information storage unit operable to correlate and to hold information defining a flow of a packet with information concerning the priority of the packet belongs to the flow;
a quality determination unit operable to dynamically determine the priority of a packet belongs to a flow in accordance with a specific policy; and
a mode decision unit operable to perform a static/dynamic decision, that is, whether to statically determine the information concerning the priority of the received packet as the information held by said flow control information storage unit, or to dynamically determine by said quality determination unit.

58. The packet transmission apparatus according to claim 57,
wherein the information concerning the priority of a packet belongs to a flow of said flow control information storage unit is configured so as to be a basis for the static/dynamic decision.

59. The packet transmission apparatus according to claim 57,
wherein the information concerning the priority of a packet belongs to a flow of said flow control information storage unit indicates, when indicating to decide dynamically, an invalid priority.

60. The packet transmission apparatus according to claim 57,
wherein said queue and said quality determination unit are made as a pair one-to-one with each other, and the number of said pairs is the number of policies required.

61. The packet transmission apparatus according to claim 57,
wherein the priority is a threshold for available capacity of a relevant queue, said discard decision unit decides whether or not to discard the received packet based on the threshold for the relevant queue and the available capacity.

62. The packet transmission apparatus according to claim 57,
wherein said quality determination unit refers to the accumulated used amount of the relevant flows and dynamically determines the priority.

63. The packet transmission apparatus according to claim 57,
wherein said quality determination unit refers to the continuous time of the relevant flow and dynamically determines the priority.

64. The packet transmission apparatus according to claim 57,
wherein said quality determination unit dynamically determines the priority using a random number.

65. The packet transmission apparatus according to claim 57,
wherein said quality determination unit refers to the number of active flows and dynamically determines the priority.

66. The packet transmission apparatus according to claim 57,
wherein said quality determination unit dynamically determines the priority so that a flow of which transmission has started earlier becomes advantageous on the in order of arrival basis based on the transmission start time of the flows.

67. The packet transmission apparatus according to claim 57,
wherein said quality determination unit dynamically determines the priority so that a flow of which transmission has started later becomes advantageous on the in reverse order of arrival basis based on the transmission start time of the flows.

68. A packet transmission method for handling the flows having a common policy as a set of service quality, comprising;
defining an algorithm suitable to a policy particular to the set of service quality;
dynamically determining the priority of the packets of the flows belongs to the set of service quality while reflecting the usage situation of the transmission resources in accordance with the defined algorithm; and
transmitting the packets of the flows belong to the set of service qualities in accordance with the determined priority.

69. The packet transmission method according to claim 68,
wherein a plurality of flows belong to a plurality of sets of service qualities having a different policy, respectively, flows through a common transmission path in a mixed manner, and are handled independently from each other based on the set of service qualities.

70. The packet transmission method according to claim 68,
wherein a set of service qualities shared by the used queues is handled as a set of shared resources.

71. The packet shaper according to claim 43,
wherein said flow control unit determines the priority of the packet belongs to the flow based on the number of active flows at a transmission start point of the flow.

72. The packet shaper according to claim 43,
further comprising an input unit for receiving user input,
wherein, when a user input is given from said input unit, said flow control unit changes the priority of a packet belongs to a present flow.

73. The packet shaper according to claim 72,
wherein, when a user input is given from said input unit, said flow control unit fixes the priority of a packet belongs to a present flow.

74. The packet shaper according to claim 73,
wherein, when a user input is given from said input unit, said flow control unit makes the priority of a packet belongs to a present flow higher than the present priority.

75. The packet shaper according to claim 73,
wherein, when a user input is given from said input unit, said flow control unit makes the priority of a packet belongs to a present flow lower than the present priority.
